(19) United States
(12) Patent Application Publication
(10) Pub. No.: US 2008/0319938 A1
(43) Pub. Date: Dec. 25, 2008

(54) SYSTEM AND METHOD FOR IDENTIFYING PROSPECTS FOR MORTGAGE REFINANCING

(76) Inventor: Jeffrey Rabinovich, New York, NY (US)

Correspondence Address: DREIER LLP;Susan Formicola, 499 PARK AVE, NEW YORK, NY, 10022, US

(21) Appl. No.: 12/017,738

(22) Filed: Jan. 22, 2008

Related U.S. Application Data
(60) Provisional application No. 60/886,052, filed on Jan. 22, 2007.

(51) Int. Cl. G06F 17/30

(52) U.S. Cl. 707/1; 707/E17.001

(57) ABSTRACT

A system and method for map-based mortgage information determination includes displaying a geographic location on a map display. The method and system further includes populating the map display with visual property indicators, where each of the property indicators indicate a property having property information associated therewith and receiving an input selection command including at least one property. The system and method further includes accessing a mortgage data database based on the at least one property, retrieving mortgage data for the least one property and displaying the property information and mortgage data for the at least one property

### PRIORITY CLAIM

This application is claims the benefit of U.S. Provisional Application No. 60/886,052, entitled “SYSTEM AND METHOD FOR IDENTIFYING PROSPECTS FOR MORTGAGE REFINANCING,” filed on Jan. 22, 2007, which is hereby incorporated by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### CROSS REFERENCE TO RELATED REFERENCES

The present application is related to the U.S. patent application Ser. No. 10/639,611 entitled “User Interface and Method for Facilitating a Realty Transaction” filed Aug. 12, 2003, the entire disclosure of which is incorporated herein by reference.

### BACKGROUND OF THE INVENTION

Public realty information may be used for identifying and analyzing mortgage information related to a plurality of properties. The public realty information is often located in depositories held and maintained by state and/or local governments. The Real Property Assessment Division (“RPAD”) system in New York, for example, maintains a compilation of information (i.e., block and lot numbers) relating to realties within its jurisdiction. However, the RPAD system does not allow the public to conduct comprehensive searching of information and some of the information is incomplete, consisting of limited information fields. Furthermore, a user can only search information by the block and lot number. For example, the RPAD system lacks information related to a percentage of a given property that is vacant, information relating to an owner of the property, information relating to properties in other jurisdictions, etc.

Traditional methods of utilizing the public realty information consisted of transcribing the information on note cards. Additionally, First American Real Estate Solution markets a software product, entitled Win2Data®, which is a database of realty information, such as the name of the property owner and mortgage lendor for a given property. However, the Win2Data software does not allow for simultaneous display of multiple records, its searching capabilities are limited and user access is restricted to the realty information provided in the database included with the Win2Data software.

These and other disadvantages contribute to the absence of an effective system or method for processing financial and other information related to a realty transaction and, in particular, to analyzing mortgage information for a plurality of properties.

### BRIEF DESCRIPTION OF THE DRAWINGS

FIG. 1 shows a system for facilitating mortgage transactions according to an exemplary embodiment of the present invention;

FIG. 2 shows a method for generating a mortgage data map interface according to an exemplary embodiment of the present invention;

FIG. 3 shows a screenshot displaying a mortgage data map interface according to an exemplary embodiment of the present invention;

FIG. 4 shows a screenshot displaying a map interface module screen according to an exemplary embodiment of the invention;

FIG. 5 shows a method for generating a bank list according to an exemplary embodiment of the present invention;

FIG. 6 shows a screenshot displaying a bank list module screen according to an exemplary embodiment of the present invention;

FIG. 7 shows a screenshot displaying a bank list according to an exemplary embodiment of the present invention;

FIG. 7A shows a screenshot displaying a short bank list according an exemplary embodiment of the present invention;

FIG. 8 shows a method for generating multiple mortgage documents according to an exemplary embodiment of the present invention;

FIG. 9 shows a screenshot displaying a mortgage document creation module screen according to an exemplary embodiment of the present invention;

FIG. 10 shows a screenshot displaying a template selection module according to an exemplary embodiment of the present invention;

FIG. 11 shows a method for determining a deal timeline according to an exemplary embodiment of the present invention;

FIG. 12 shows a screenshot displaying a master screen according to an exemplary embodiment of the present invention;

FIG. 13 shows a screenshot displaying a selection criteria interface for a deal timeline according to an exemplary embodiment of the present invention;

FIG. 14 shows a screenshot displaying a deal timeline interface according to an exemplary embodiment of the present invention;

FIG. 15 shows a method for generating a deal summary according to an exemplary embodiment of the present invention;

FIG. 16 shows a screenshot displaying a master screen according to an exemplary embodiment of the present invention;

FIG. 17 shows a screenshot displaying a deal summary interface according to an exemplary embodiment of the present invention; and

FIGS. 18-57 show exemplary embodiments of screenshots generated by various modules of a mortgage transaction application according to the present invention.

### DETAILED DESCRIPTION OF THE PREFERRED EMBODIMENTS

In the following description of embodiments of the invention, reference is made to the accompanying drawings that form a part hereof and in which is shown by way of illustration a number of exemplary embodiments in which the invention may be practiced. It is to be understood that other embodiments may be utilized and structural changes may be made without departing from the scope of the present invention.

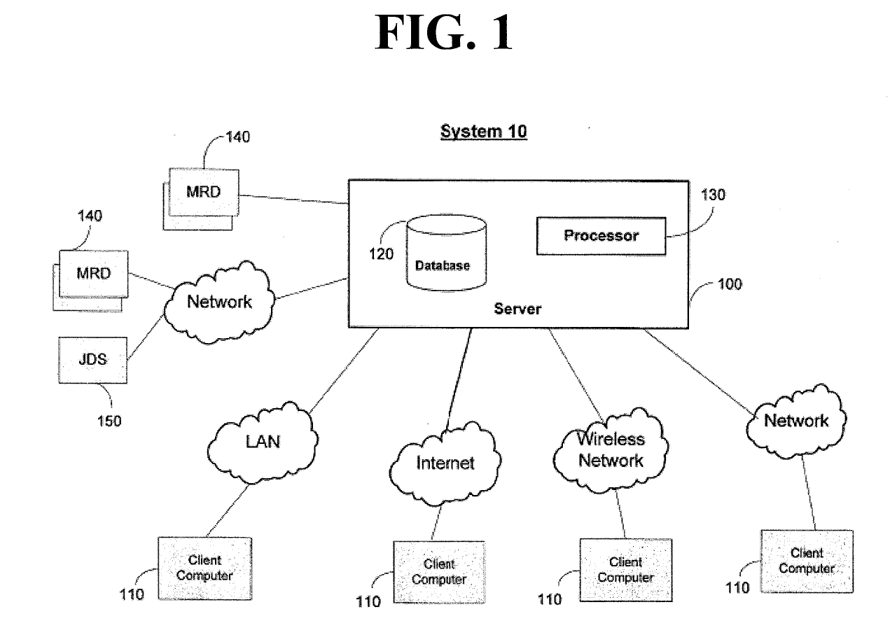

FIG. 1 shows an exemplary embodiment of a system 10 for identifying prospects for mortgage refinancing. The system 10 includes a server 100 accessible by at least one client computer 110 communicatively connected to the server 100 via, for example, a dedicated LAN, the Internet, a wirelessly connection or any other data communication modality. The server 100 may be a processor-based computing device (e.g., having processor 130) which has access to a database 120 storing property data (e.g., address, building owner, etc.), mortgage data (e.g., loan type, term, date, etc.) and transaction data (e.g., bank, mortgage broker, etc.) related to the mortgage data for a plurality of properties. The present invention contemplates that the components of the system 10 may be arranged in any distributed or non-distributed manner and utilize varying security/authorization schemes for providing access to the server 100 for users of the client computers 110. For example, a user may be granted access to the database 120 via a graphical user interface (“GUI”) displayed at the client computer 110. The user utilizes the GUI to retrieve and navigate between information screens, navigate fields, enter data, etc. As used herein, the user may be a private individual, a broker, a customer service representative (“CSR”), etc.

Mortgage-related documents (“MRDs”) 140 may be connected to the server 100 for importation into the database 120. The MRDs 140 reside on a computer-readable medium and/or exist in a traditional format, such as paper or microfiche. The information contained within the MRDs 140 can be imported in any number of ways, including via a network, dedicated connection, manual data entry, VPN, and other methods known in the art. In one embodiment, a jurisdiction document system (“JDS”) 150 is connected to the server 100 via a network, such as the Internet. The JDS 150 contains publicly available documents relating to properties in a given jurisdiction and may be used to populate/update the data in the database 120. The JDS 150 is accessible via the GUI on the client computer 110. As understood by those of skill in the art, more than one JDS 150 may be present for multiple jurisdictions.

In the exemplary embodiment, a mortgage transaction application may be installed on the client computer 110 and/or presented as a network site (e.g., a WWW page). The mortgage transaction application may be utilized for retrieving and analyzing the data on the database 120, generating mortgage leads, identifying prospects for mortgage refinancing, etc. Various modules in the mortgage transaction application including, but not limited to, a map module, a bank list module, a mortgage document creation module, a deal timeline module and a deal summary module, utilize the data in the database 120 and/or data input by the user(s). While the functionality of the various modules will be described below, those of skill in the art will understand that the mortgage transaction application may include further modules, patches, upgrades, etc. The modules may accessed via buttons, tabs, etc. on a master screen of the mortgage transaction application or via hotkeys on a keyboard/pad, audible commands, tactile input on a touch screen, etc.

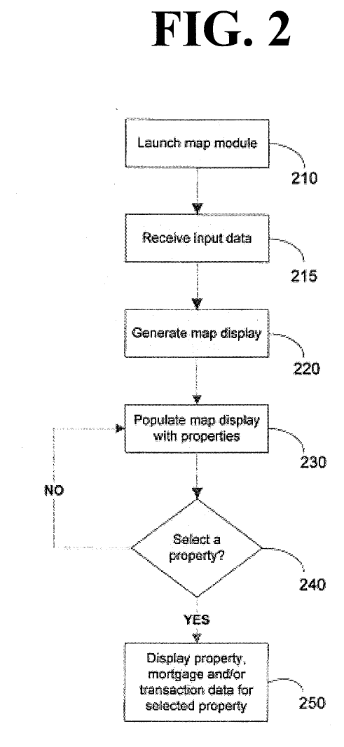

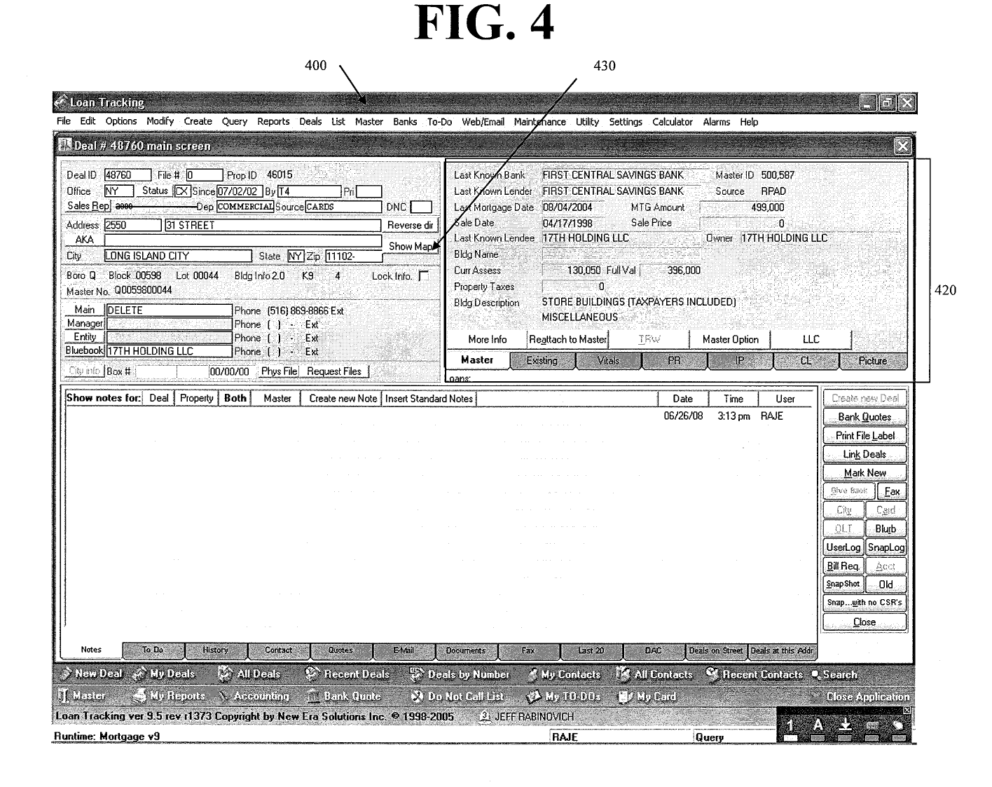

FIG. 2 shows an exemplary embodiment of a method 200 for generating a mortgage data map interface according to the present invention. In step 210, a user selects a button, tab, etc. on a screen generated by the mortgage transaction application launches the map module. The button/tab corresponding to the map module may be visible while the user is navigating through the screens and utilizing different modules of the mortgage transaction application. As such, the user may launch the map module from any screen in the mortgage transaction application. For example, as shown in FIG. 4, the user may be viewing a deal screen 400 which displays property data, mortgage data, broker notes, etc. related to a selected property. When a show map button 430 on the deal screen 400 is clicked, the map module may be launched and allowing the user to view a location corresponding to the property data on a map display, as will be explained below.

In step 215, the map module receives input data from the user or from the server 100 at the user's request. For example, the input data may include one or more property addresses that the user desires to locate on the map display. In another exemplary embodiment, the input data may include a predefined geographic region for which the user desires to view properties (e.g., properties within x miles of <address>). In a further exemplary embodiment, the input data may be obtained from another module of the mortgage transaction application. For example, the user may instruct the map module to obtain the locations of all properties identified as potential refinancing leads (accomplished via a lead generation module) and plot those properties on the map display.

In step 220, the server 100 generates the map display based on the input data. The map display may correspond to a geographic region which includes all of the locations of the properties identified in the input data. In other embodiments, the map display may include multiple geographic regions. For example, the geographic regions may display properties within a predefined distance of each other, with a predefined radius, in a selected borough, in a selected county, etc. As understood by those of skill in the art, the server 100 may generate the map display by utilizing a mapping application programming interface (API) available from, for example, Google®, Yahoo!®, MapQuest®, etc.

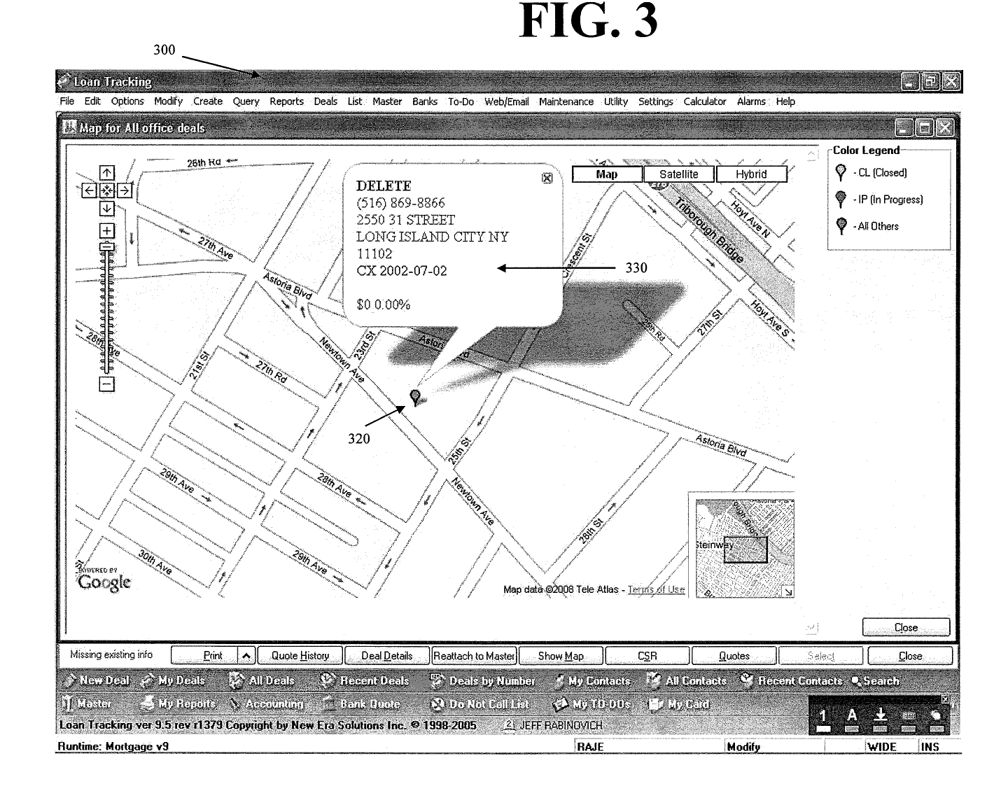

In step 230, the map display is populated with the properties identified in the input data. FIG. 3 shows an exemplary embodiment of a map screen 300 displaying the map display. A property identifier 320 corresponding to a property address from the input data is shown on the map display. There may be a plurality of property identifier 320 corresponding to each of the property addresses identified in the input data. As is known in the art, the user may adjust a resolution of the map display by zooming in and out from, for example, a state level to a street level and change views from graphical to satellite images or a hybrid thereof.

In step 240, it is determined whether the user has selected a property displayed on the map display. For example, the map module may utilize computer code which interprets mouse clicks, mouse-overs, screen touches, audible commands and/or keystrokes to determine whether the user has selected a property on the map display and which property has been selected. If the user does not select a property on the map display, the mortgage transaction application may respond to other user events (e.g., switching modules or applications, etc.).

In step 250, the property data corresponding to the selected property is displayed on the map display. For example, as shown in FIG. 3, a window 330 may be displayed on the map display when the user selection is detected. The window 330 may be populated with the property data which may include, for example, an address, a property contact (e.g., super, owner, etc.) and mortgage data corresponding to the selected property. The property data may be obtained from the database 120 on the server 100 and may include all or selected portions of the data displayed on the deal screen 400 in FIG. 4. That is, for example, the mortgage data may correspond to mortgage data 420 shown on the deal screen 400.

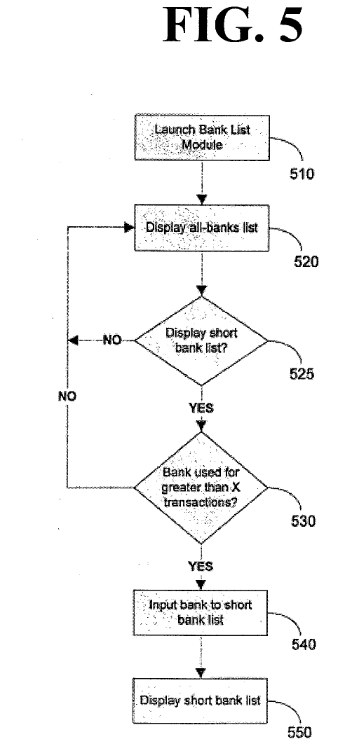

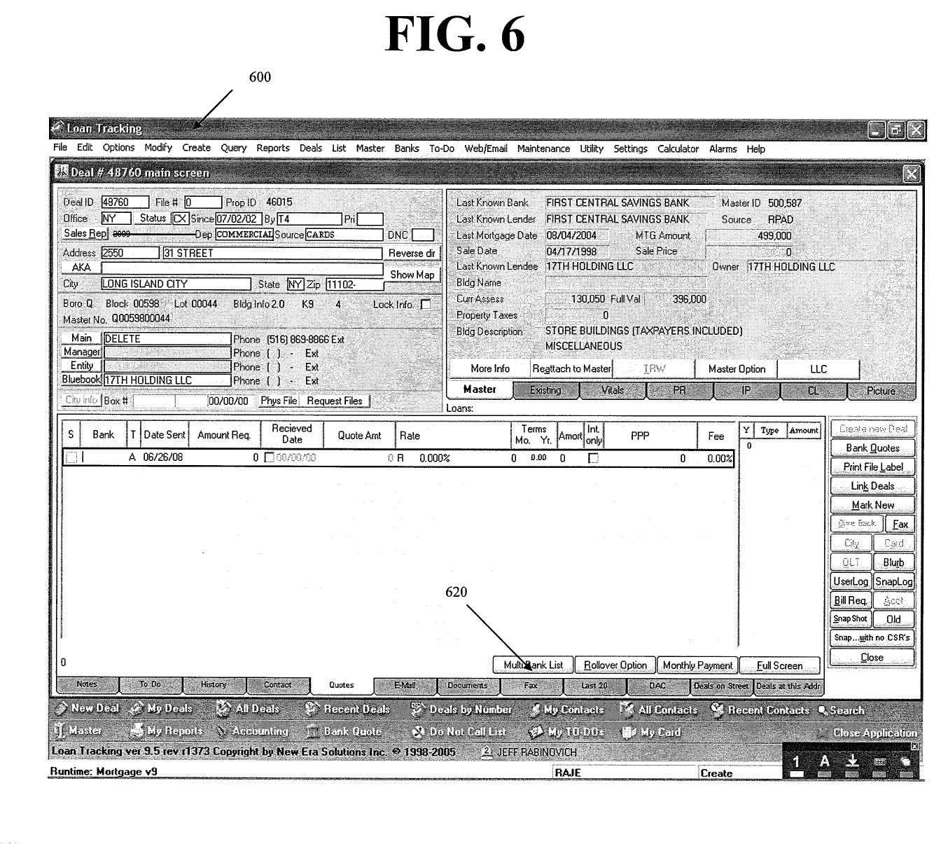

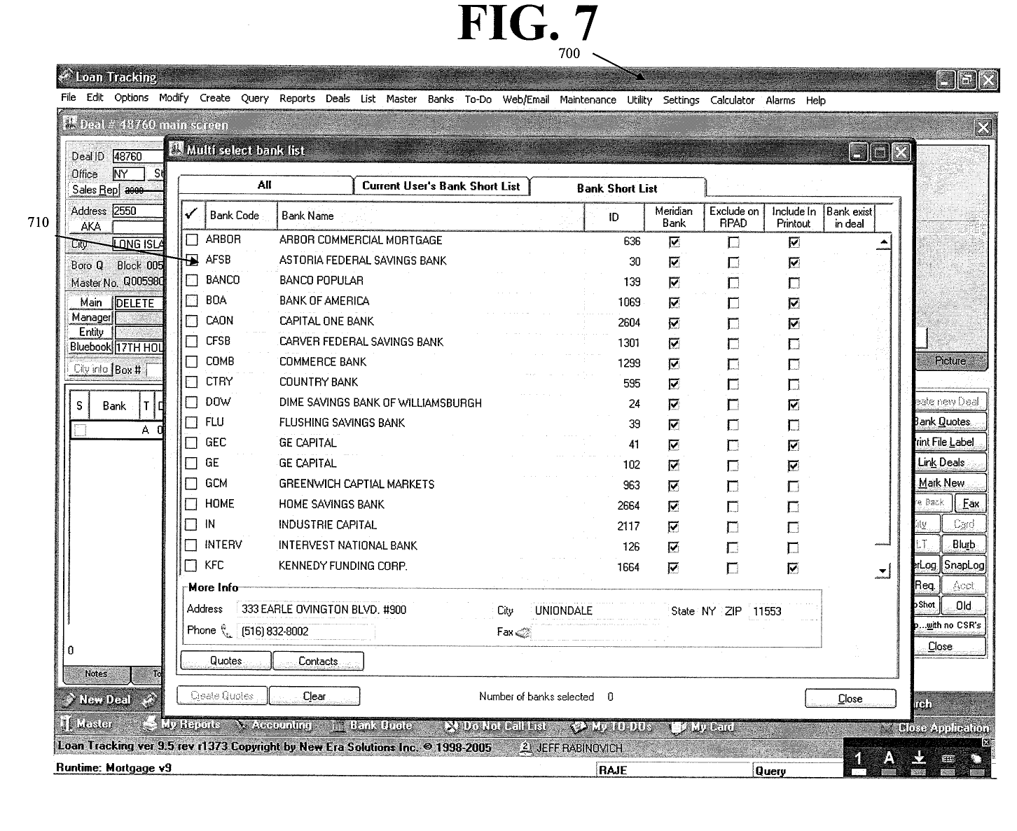

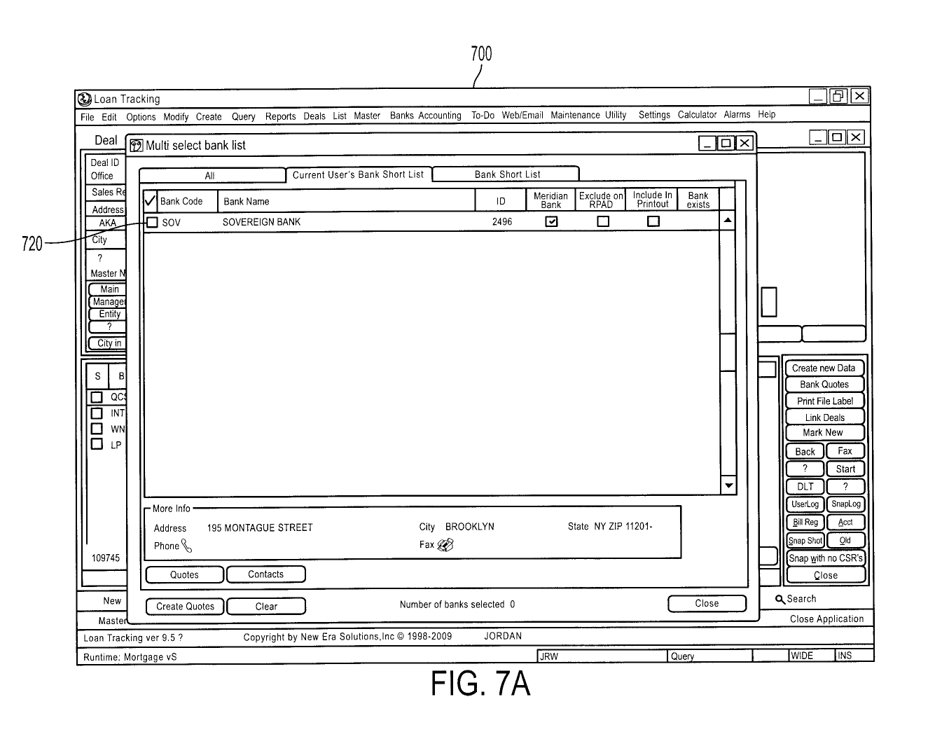

FIG. 5 shows an exemplary embodiment of a method 500 for generating a bank list according to the present invention. In step 510, the user selects a button, tab, etc. on a screen generated by the mortgage transaction application which launches the bank list module. The button/tab corresponding to the bank list module may be visible while the user is navigating through the screens and utilizing different modules of the mortgage transaction application. As such, the user may launch the bank list module from any screen in the mortgage transaction application. For example, as shown in FIG. 6, the user may be viewing a deal screen 600 which displays property data, mortgage data, broker notes, contacts, etc. related to a selected property. When a bank list button 620 on the deal screen 600 is clicked, the bank list module may be launched and display a bank list screen/interface 700 (FIG. 7) for identifying banks utilized in mortgage and re-financing transactions, as will be explained below.

In step 520, an all-banks list 710 is displayed on the bank list screen 700. The all-banks list 710 may identify all of the banks that have been used for purchase, mortgage and re-financing transactions for all of the properties identified in the system 10. The user may scroll through the all-banks list 710 (arranged by name, address, etc.) to identify the various banks and, if desired, properties that have used each of the banks. For example, selecting (e.g., double-clicking) a bank from the all-banks list 710 may display a list of transaction(s) which involved the selected bank.

In step 525, it is determined whether the user has indicated a desire to view a short bank list. For example, as shown on the bank list screen 700, the user may navigate between the all-banks list 710 and the short bank list using buttons, tabs, etc. displayed on the bank list screen 700. In step 530, for each bank in the all-banks list 710, a number of times a selected bank was used in mortgage transactions is compared to a predetermined threshold value x. If the selected bank was used in greater than x number of transactions, the selected bank is input into the short banks list (step 540). This comparison operation may be iterated over all of the banks in the all-banks list 710. In another exemplary embodiment, the predetermined threshold value x may be a monetary amount, a predefined date, a particular user, etc. For example, the short list may comprise banks used to finance multi-million dollar mortgages or used very recently or used by a preidentified user.

In step 550, the short bank list 720 is displayed on the bank list screen 700, as shown in FIG. 7A. As understood by those of skill in the art, the short bank list may be compiled when the bank list module is launched, at a predefined time (e.g., overnight), after a transaction is completed (and entered into the system 10), etc.

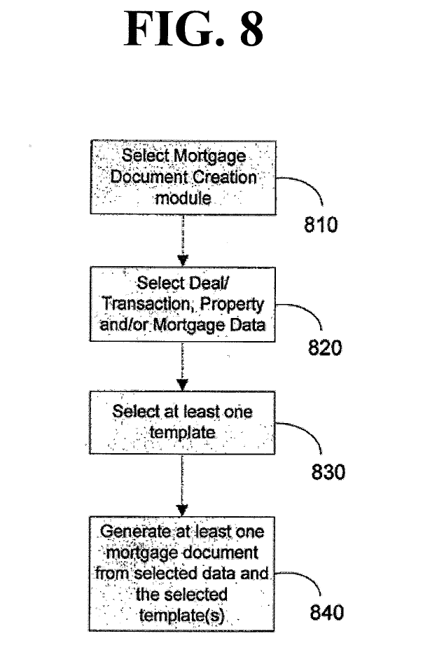

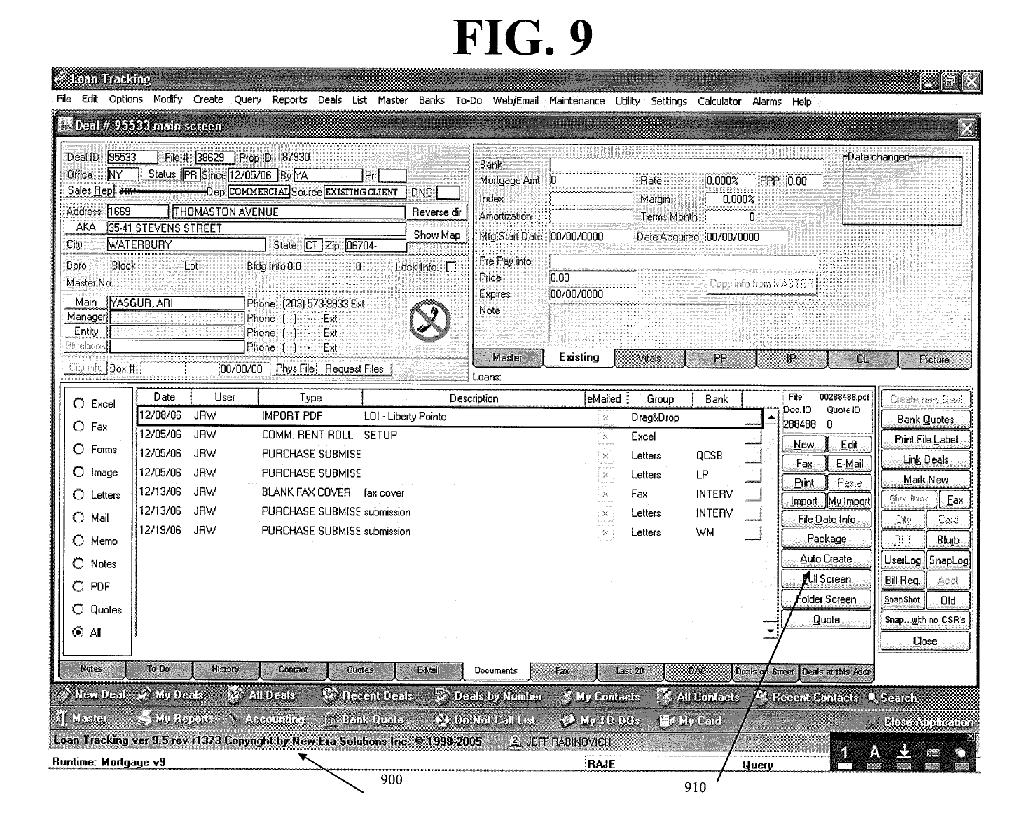

FIG. 8 shows an exemplary embodiment of a method 800 for generating multiple mortgage documents according to the present invention. In step 810, the user selects a button, tab, etc. on a screen generated by the mortgage transaction application which launches the mortgage document creation module. The button/tab corresponding to the mortgage document creation module may be visible while the user is navigating through the screens and utilizing different modules of the mortgage transaction application. As such, the user may launch the mortgage document creation module from any screen in the mortgage transaction application. For example, as shown in FIG. 9, the user may be viewing a deal screen 900 which displays property data, mortgage data, broker notes, etc. related to a selected property. When a document create button 910 on the deal screen 900 is clicked, the mortgage document creation module may be launched for allowing the user to create multiple mortgage documents for one or more properties, as will be explained below.

In step 820, the user selects deal data, property data and/or mortgage data corresponding to one or more properties. For example, the user may highlight a list of properties, flag properties while viewing them on their corresponding deal screens or otherwise indicate a selection of the properties.

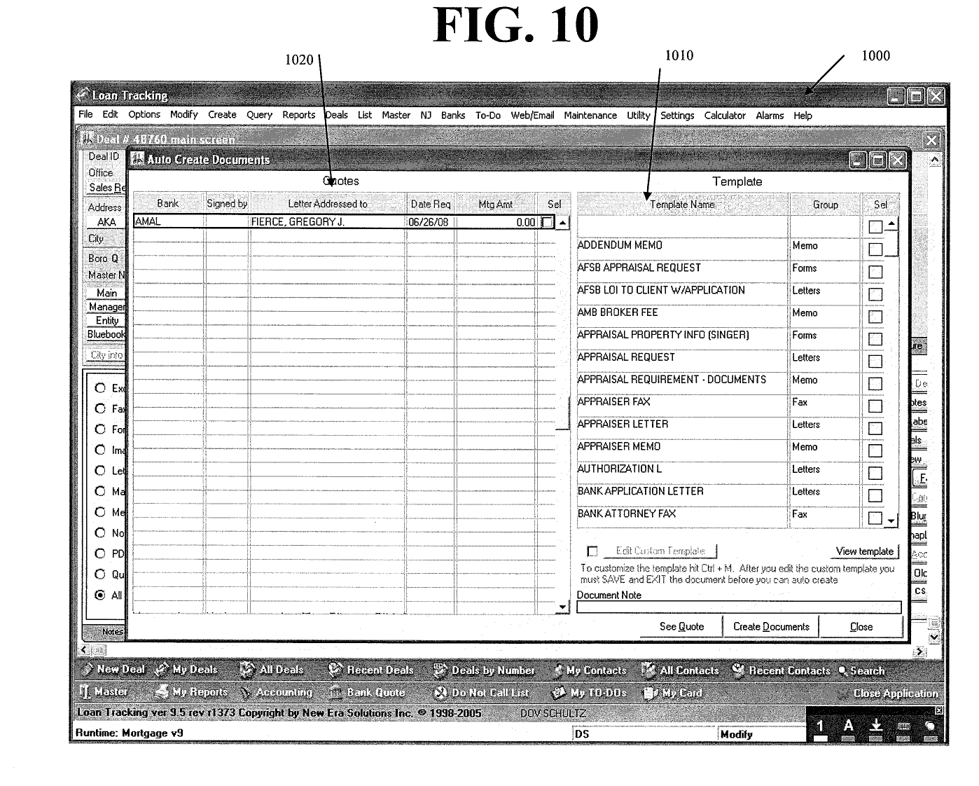

In step 830, the user selects one or more templates corresponding to the mortgage documents the user wants generated. As shown in FIG. 10, a template screen 1000 including a template list 1010 and a selected data list 1020 may be displayed. The template list 1010 may include all (or selected ones) of the templates accessible by the mortgage transaction application. The templates may be utilized for generating documents including, but not limited to, memos, letters, appraisals, reports, invoices, facsimiles, letter/fax cover sheets, mailings, etc. Additionally, the templates may include documents addressed to different entities or used for internal purposes. The selected data list 1020 may display data corresponding to properties, individuals, entities, transactions, etc. selected by the user

In step 840, at least one mortgage document is generated using the selected data and the selected template(s). The selected data may be used as input values to various parameters/fields specified in the template(s). The generated documents may then be stored and/or displayed to the user for visual confirmation that all of the selected data has been included therein. In other exemplary embodiments, the mortgage document creation module may utilize an error-checking function which before, during or after generation of the documents indicates that data is missing within the document or that the document cannot be created without the data.

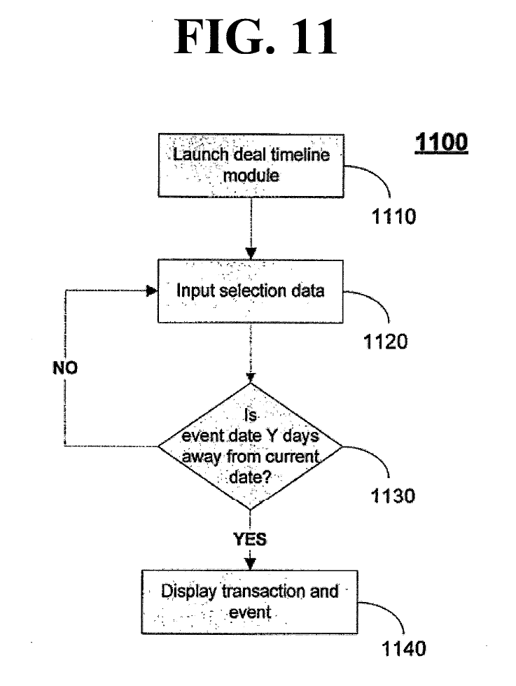

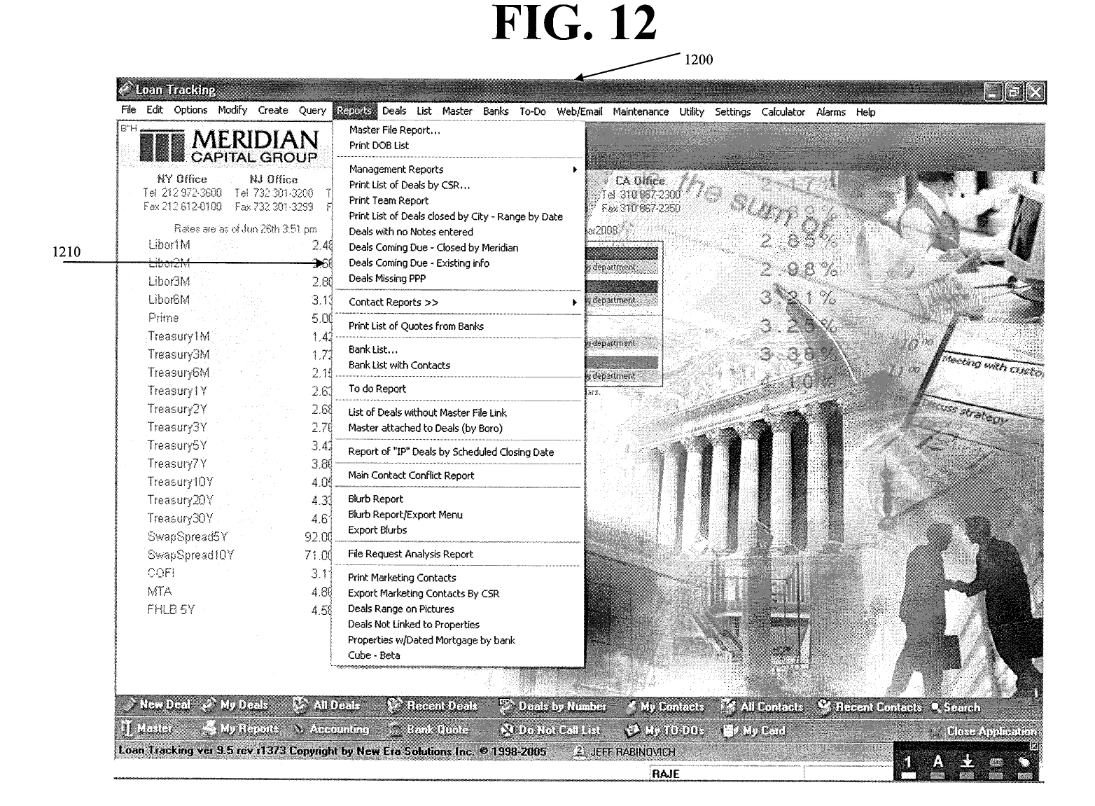

FIG. 11 shows an exemplary embodiment of a method 1100 for generating a deal timeline according to the present invention. In step 1110, the user selects a button, tab, etc. on a screen generated by the mortgage transaction application which launches the deal timeline module. The button/tab corresponding to the deal timeline module may be visible while the user is navigating through the screens and utilizing different modules of the mortgage transaction application. As such, the user may launch the deal timeline module from any screen in the mortgage transaction application. For example, as shown in FIG. 12, the user may be viewing a master screen 1200 which displays mortgage interest rates, users using the system 10, a list of most recent mortgage transactions and/or any combination of mortgage-related data. When a deals coming due report option 1210 on the master screen 1200 is clicked, the deal timeline module may be launched and display a deal timeline for one or more transactions and reminders therefore, as will be explained below.

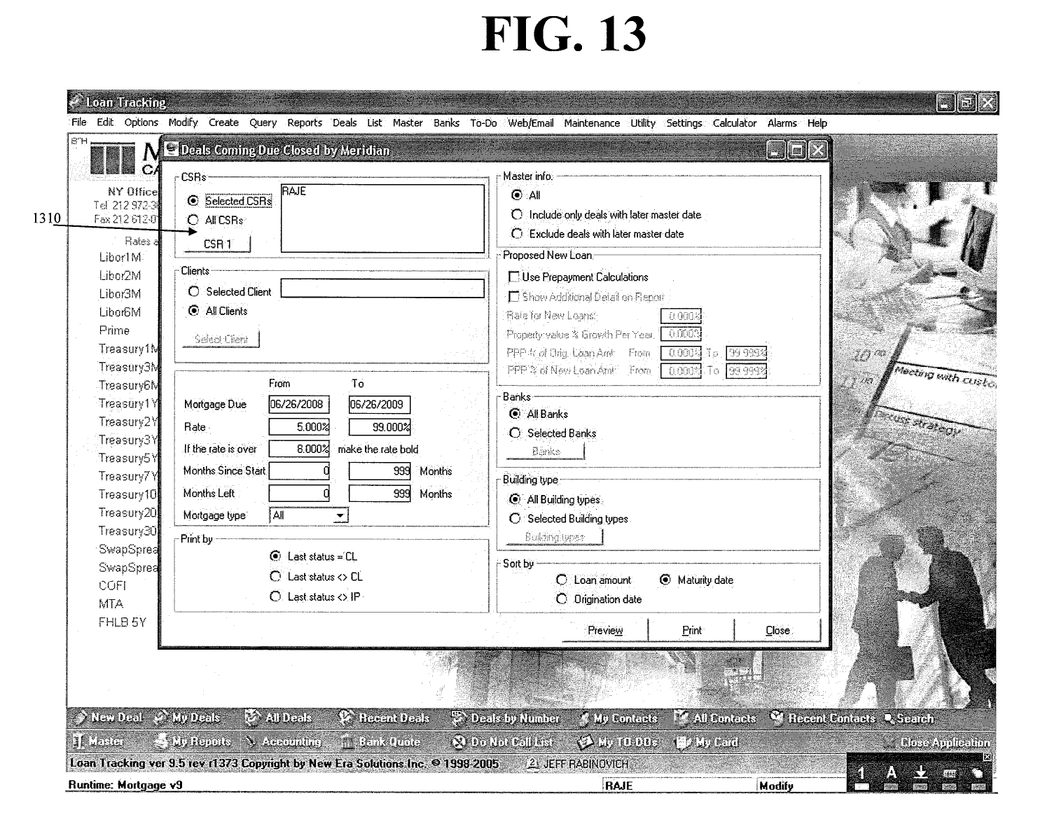

In step 1120, the user inputs selection criteria into a deal timeline interface 1310 as shown in FIG. 13. The selection criteria may include, but is not limited to, the user, the CSR identified in the transaction, a client, a date range, a rate range, a bank list of one or more banks, etc. or any combination thereof. The deal timeline module may then query the database 120 with the selection criteria to identify one or more transactions/deals which match the selection criteria.

In another exemplary embodiment, the deal timeline module may monitor deadlines, reminders, appointments, etc. as events on the deal timeline for a given transaction. In this embodiment, the method 1100 proceeds to step 1130 in which the deal timeline module compares a date of the event(s) in the deal timeline to a current date to determine whether the event date is less than a predetermined threshold number of days y from the current date.

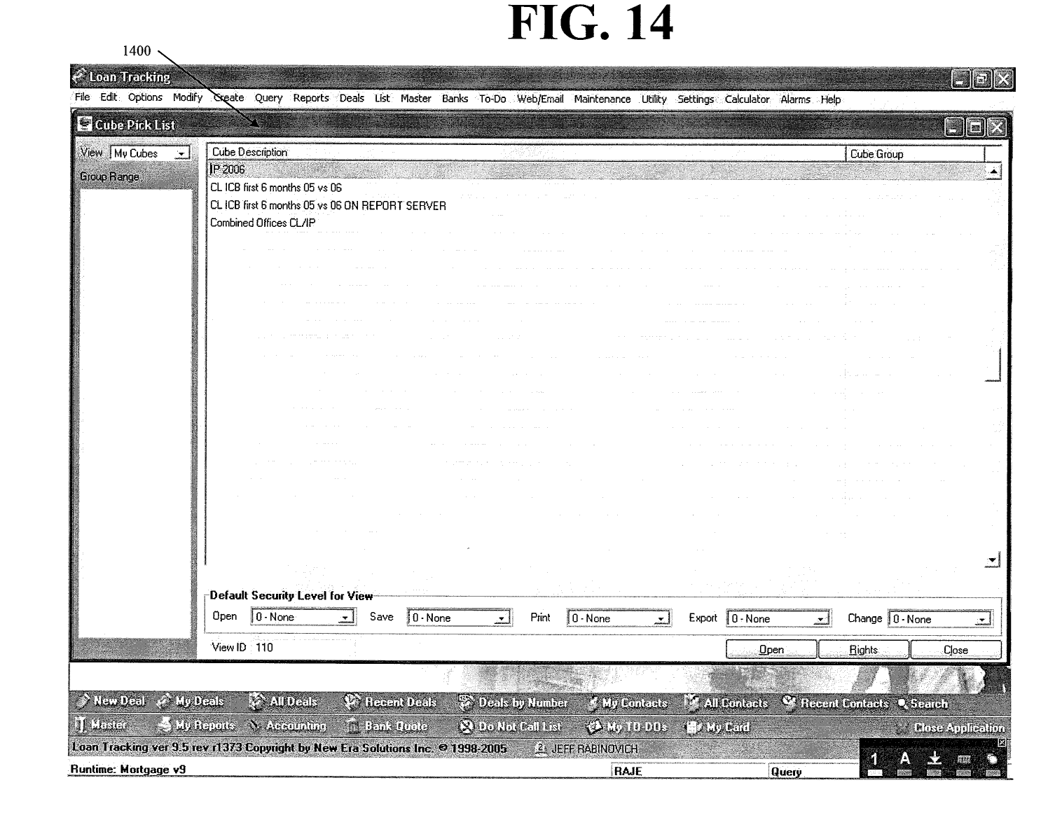

In step 1140, the event date is less than (or equal to) y days from the current date, so the deal timeline module displays the transaction, the event date and/or the event on a deal timeline interface 1400, as shown in FIG. 14. If the user selects one of the displayed transactions, a deal screen displaying all (or selected portions) of the information regarding the transaction and the corresponding deal timeline may be displayed.

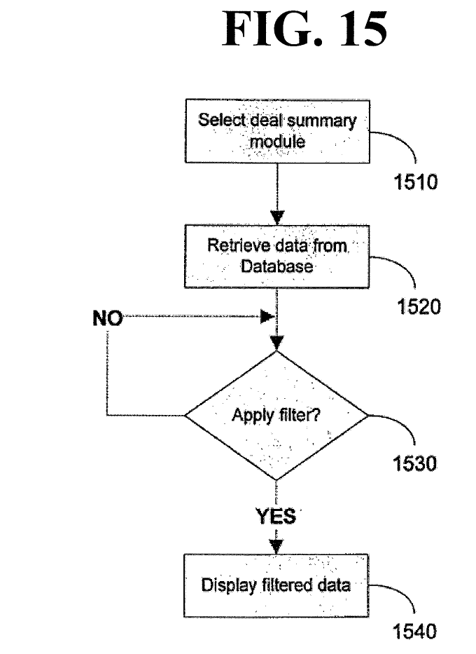

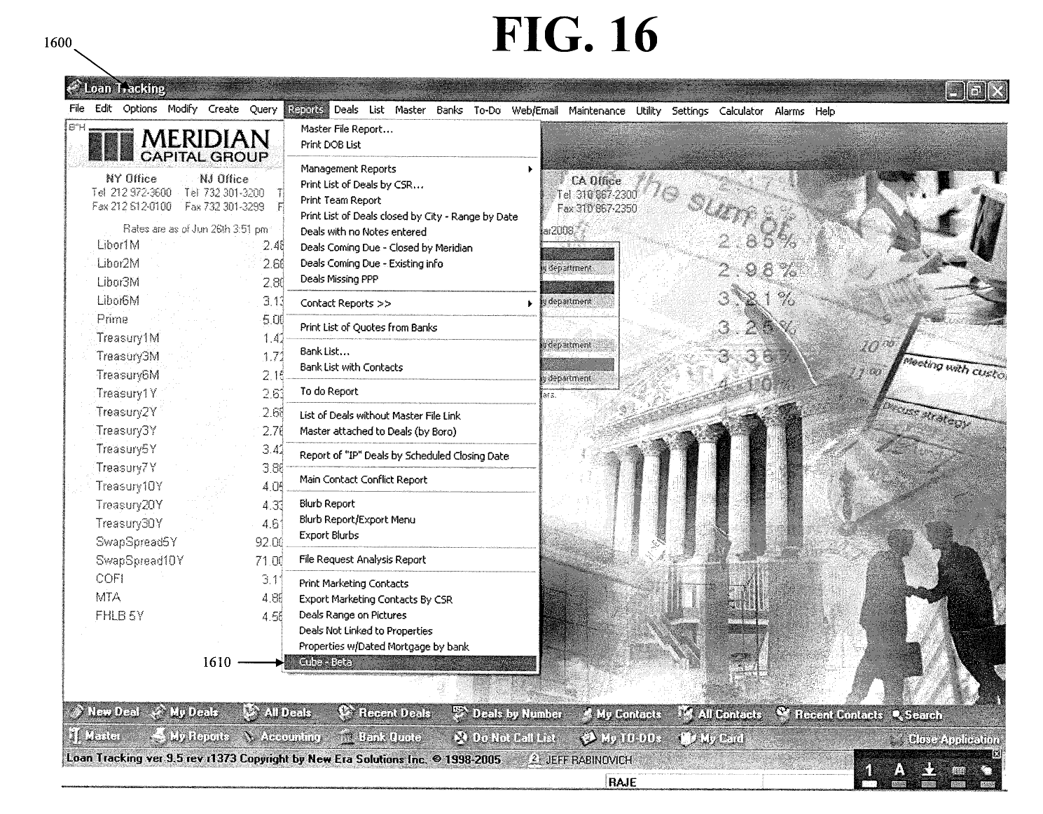

FIG. 15 shows an exemplary embodiment of a method 1500 for generating a deal summary according to the present invention. In step 1510, the user selects a button, tab, etc. on a screen generated by the mortgage transaction application which launches the deal summary module. The button/tab corresponding to the deal summary module may be visible while the user is navigating through the screens and utilizing different modules of the mortgage transaction application. As such, the user may launch the deal summary module from any screen in the mortgage transaction application. For example, as shown in FIG. 16, the user may be viewing a master screen 1600 which displays mortgage interest rates, users using the system 10, a list of most recent mortgage transactions and/or any combination of mortgage-related data. When a ‘cube’ option 1610 on the master screen 1600 is clicked, the deal summary module may be launched and display a deal summary for one or more transactions, as will be explained below.

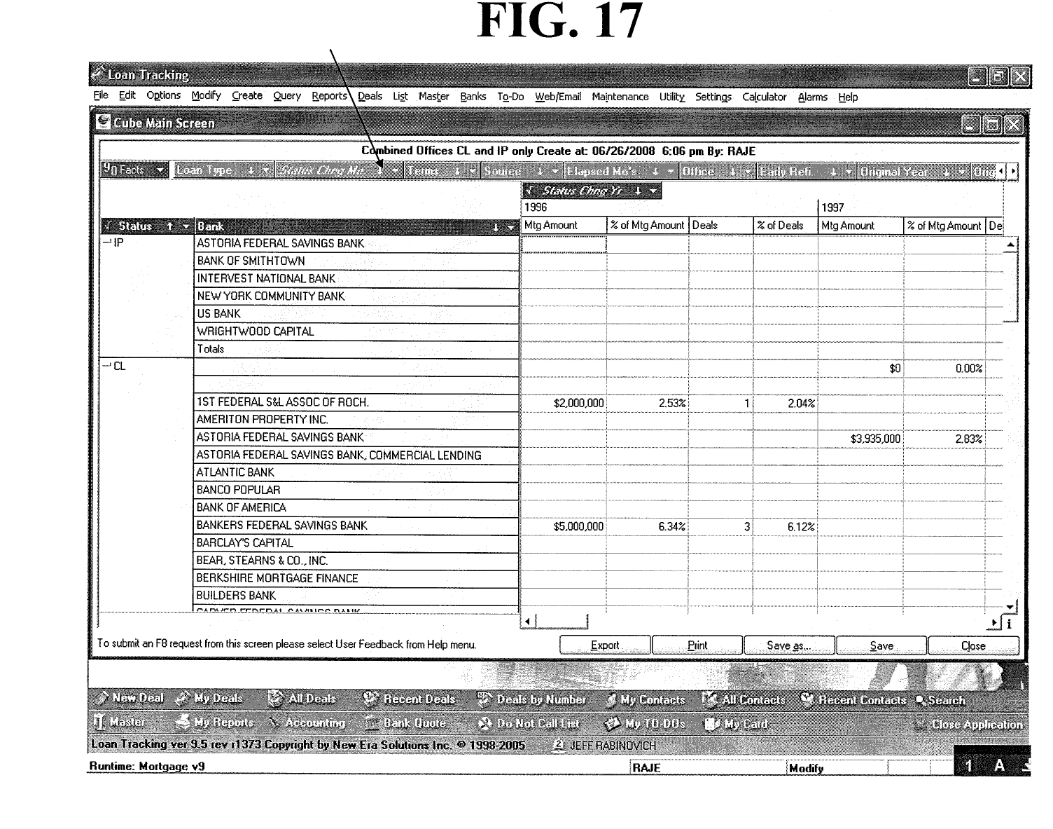

In step 1520, the deal summary module retrieves transaction data from the database 120 based on, for example, the user utilizing the deal summary module. For example, the user may have entered a log-in, password or other identifier while completing an authorization handshake with the client computer 110 and/or the server 100. The deal summary module may identify the user and retrieve the transaction data from the database 120 corresponding to transactions completed and/or pending involving the user, and/or leads generated by or for the user by the mortgage transaction application. The transaction data may be displayed on a deal summary interface 1700, as shown in FIG. 17.

In step 1530, it is determined whether a filter will be applied to the transaction data. For example, the deal summary interface 1700 may present a plurality of filters 1710-1717 which may be used to sort/filter the transaction data for generating a customized view thereof. When a filter is selected, the deal summary module analyzes and limits the transaction data to create filtered data which may then be displayed on the deal summary interface 1700 (step 1540).

The plurality of filters may include, for example, a loan type filter 1710 which sorts the transaction data based on a loan type associated with each transaction. Invoking a status change filter 1711 may sort the transaction data based on a date on which a status change (e.g., letter sent, public record filing, etc.) occurred in each of the transactions. A terms filter 1712 may sort the transaction data based on deal terms (e.g., length of mortgage, fixed/variable, rate, etc.) associated with each of the transactions. When the user selects a source filter 1713, the transaction data may be sorted based on the property data, the CSR originating the deal, etc. associated with each of the transactions. An elapsed months filter 1714 may sort the transaction data based on a number of months which have passed since the transaction was initiated.

An office filter 1715 may be utilized when, for example, the mortgage transaction application is utilized on an intranet. For example, a mortgage company owner may want to identify which office is producing the most revenue. Applying the office filter 1715 may sort the transaction data based on a home office of the CSR originating the transaction. An early refinance filter 1715 can sort the transaction data based on whether the transaction qualifies for early refinancing. That is, a refinancing module included with the mortgage transaction application may analyze existing mortgage data for selected properties and determine which properties/transactions qualify for early refinancing.

An original year filter 1717 may sort the transaction data by a year in which each transaction was originated, presenting the user with a chronological view of the transactions.

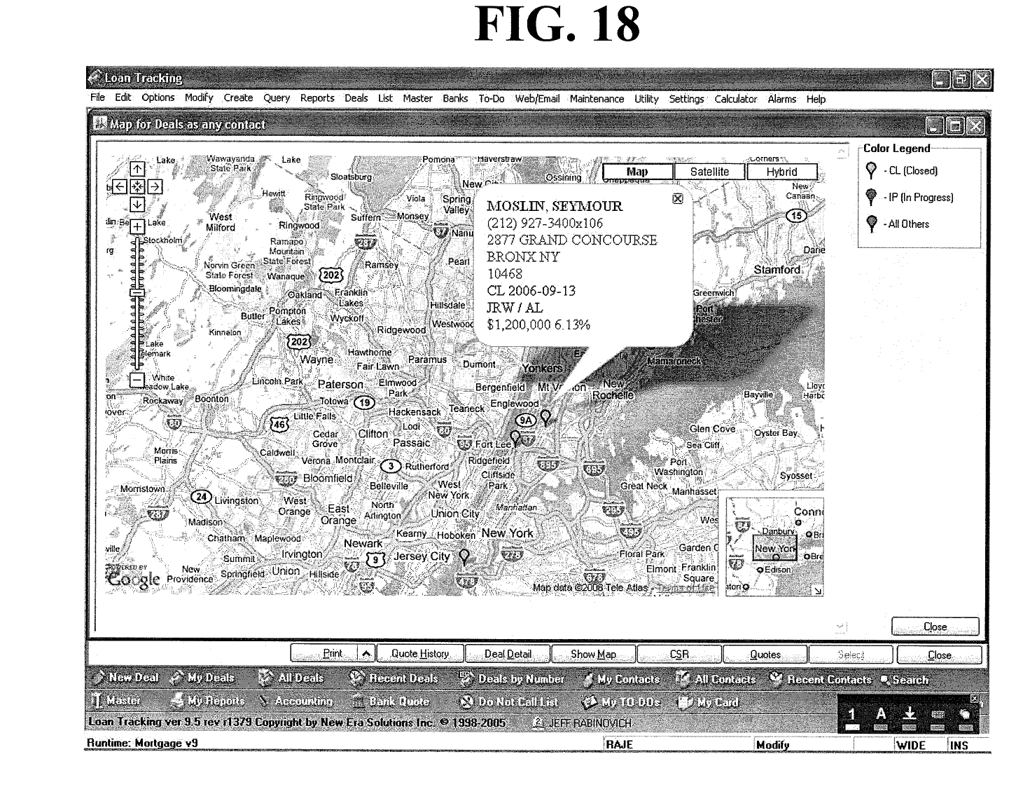

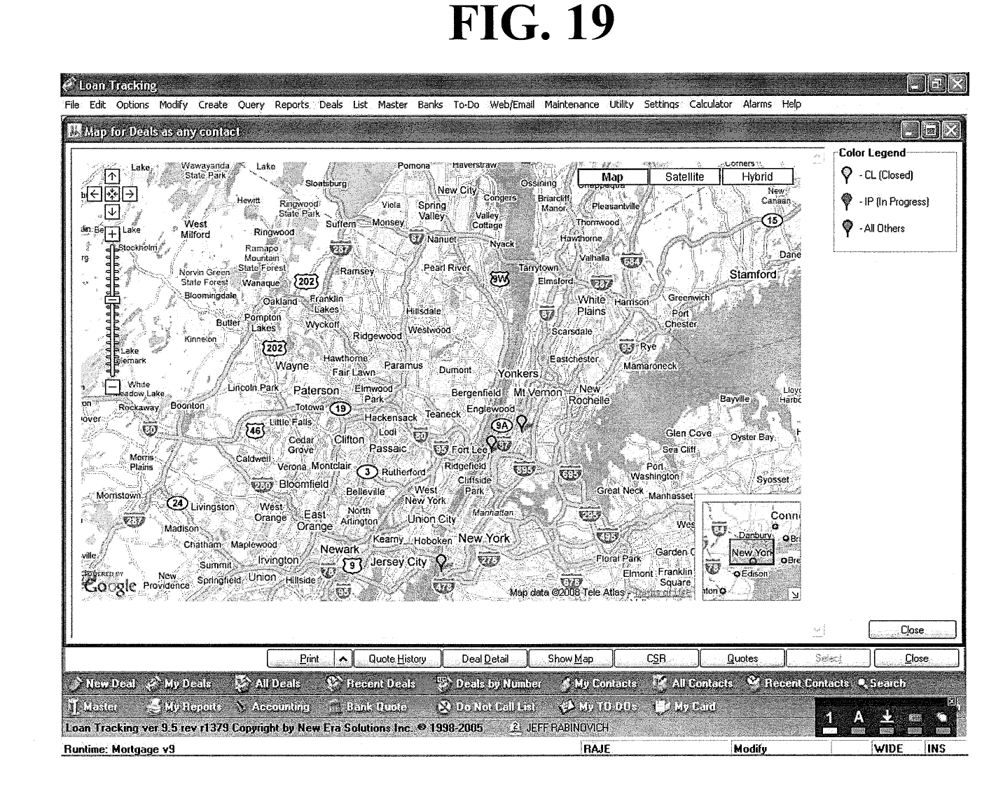

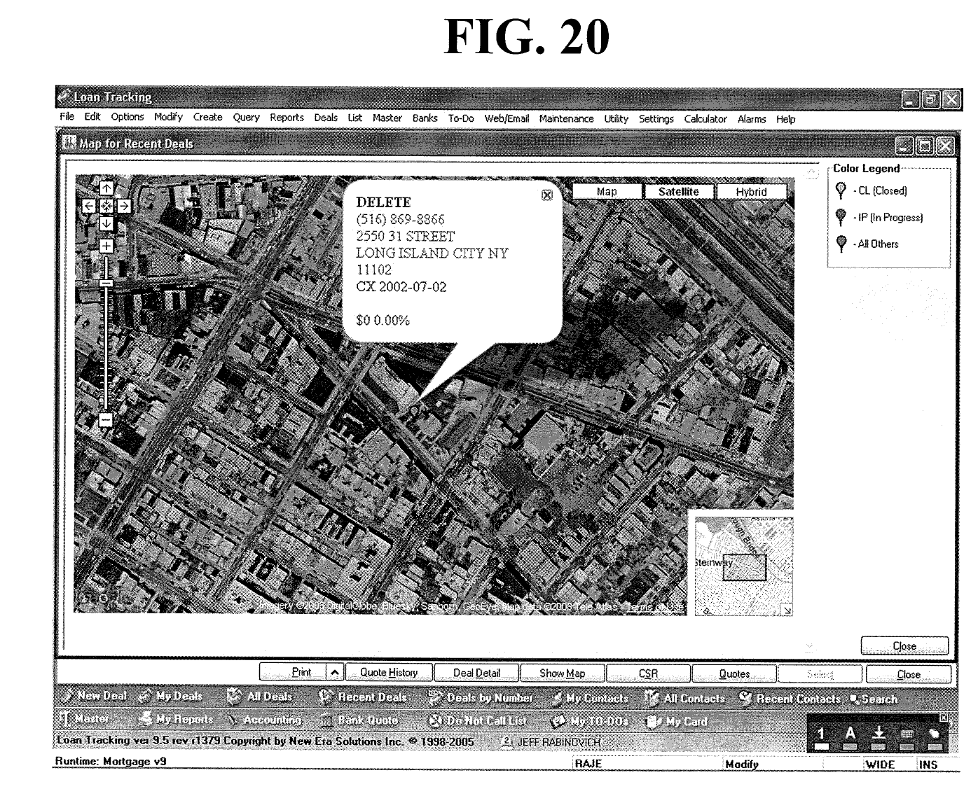

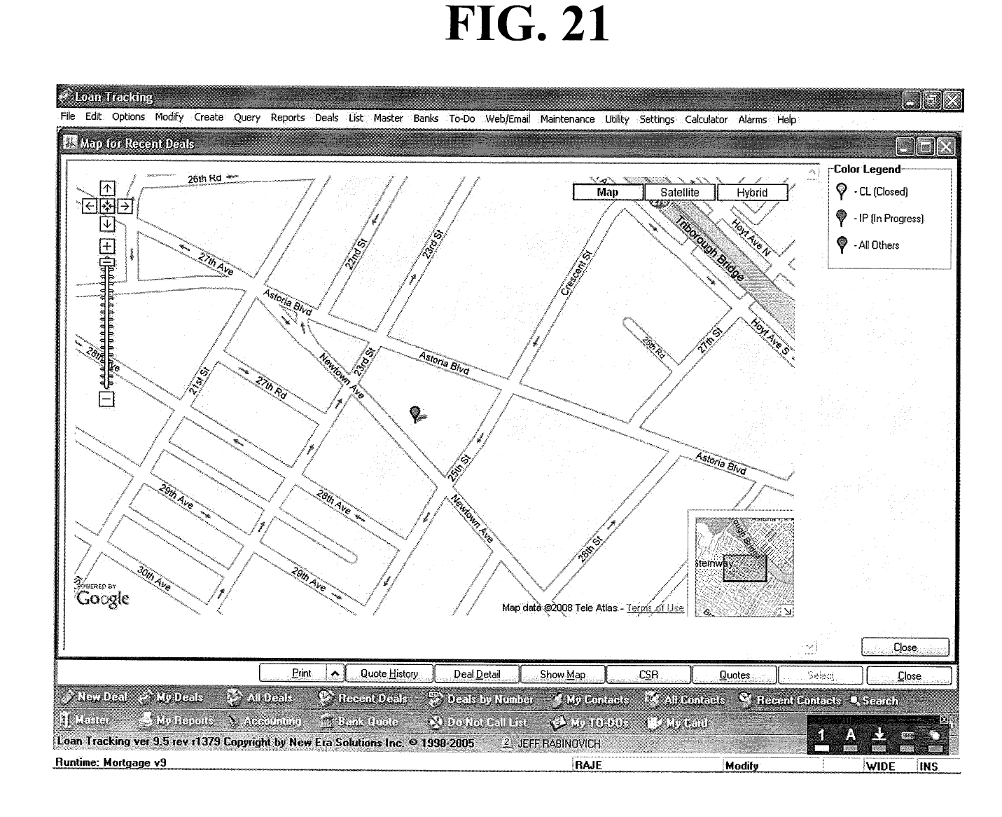

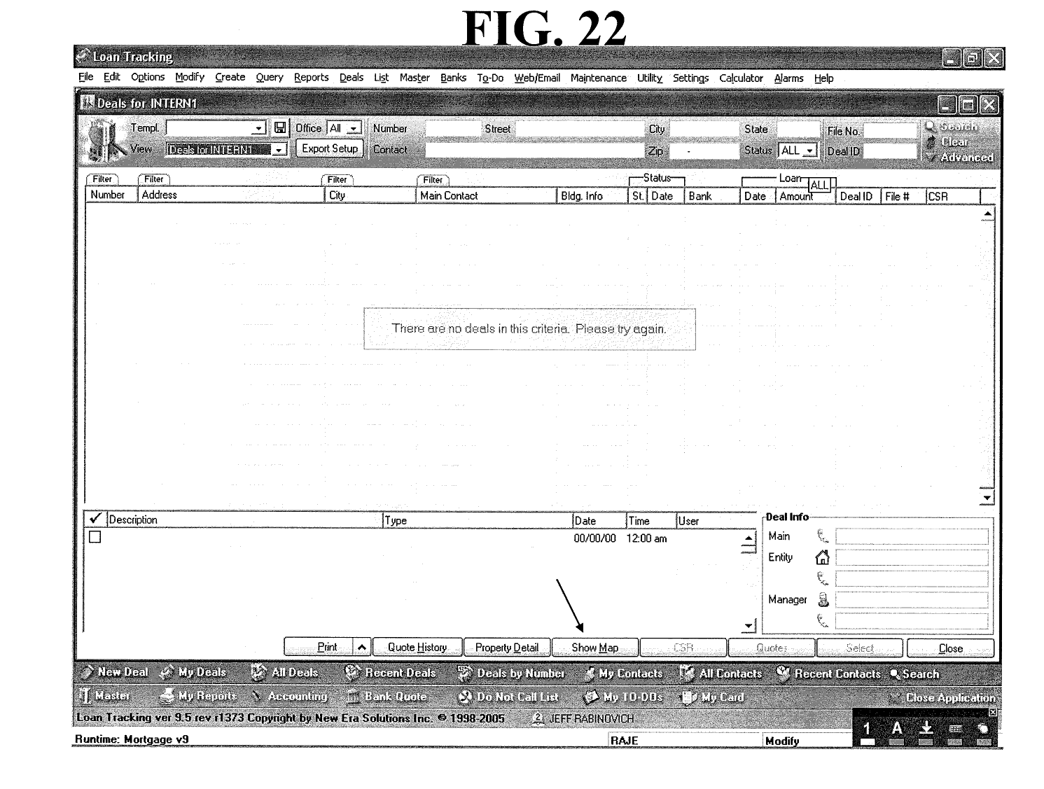

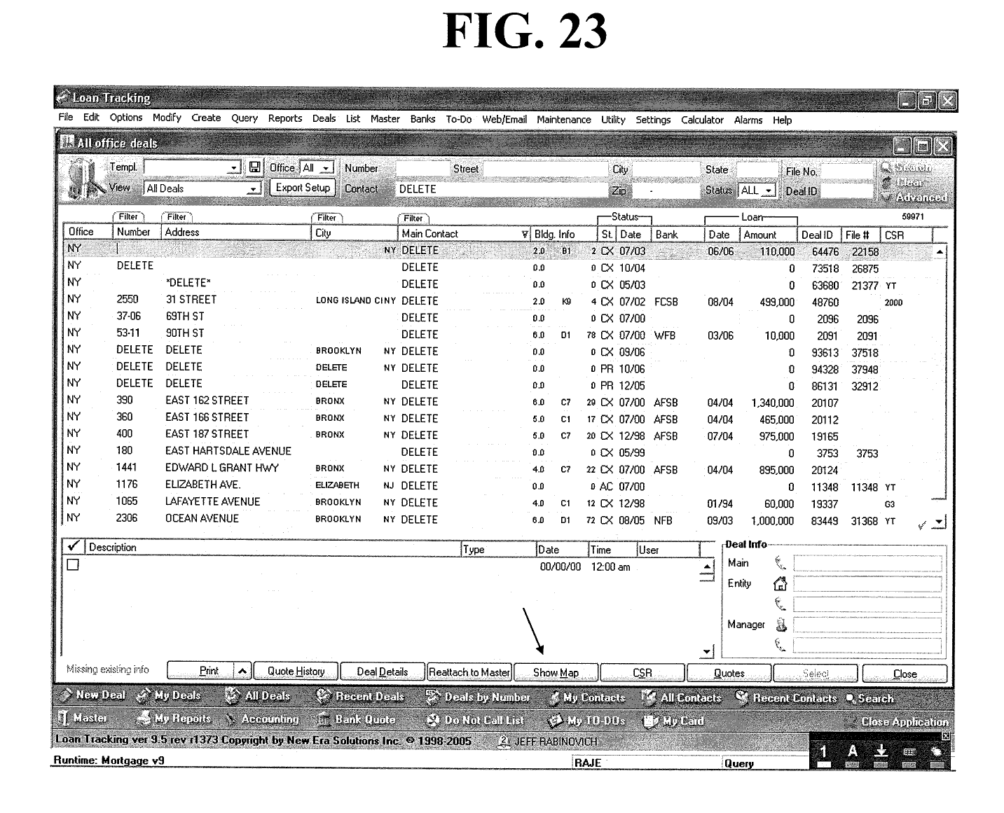

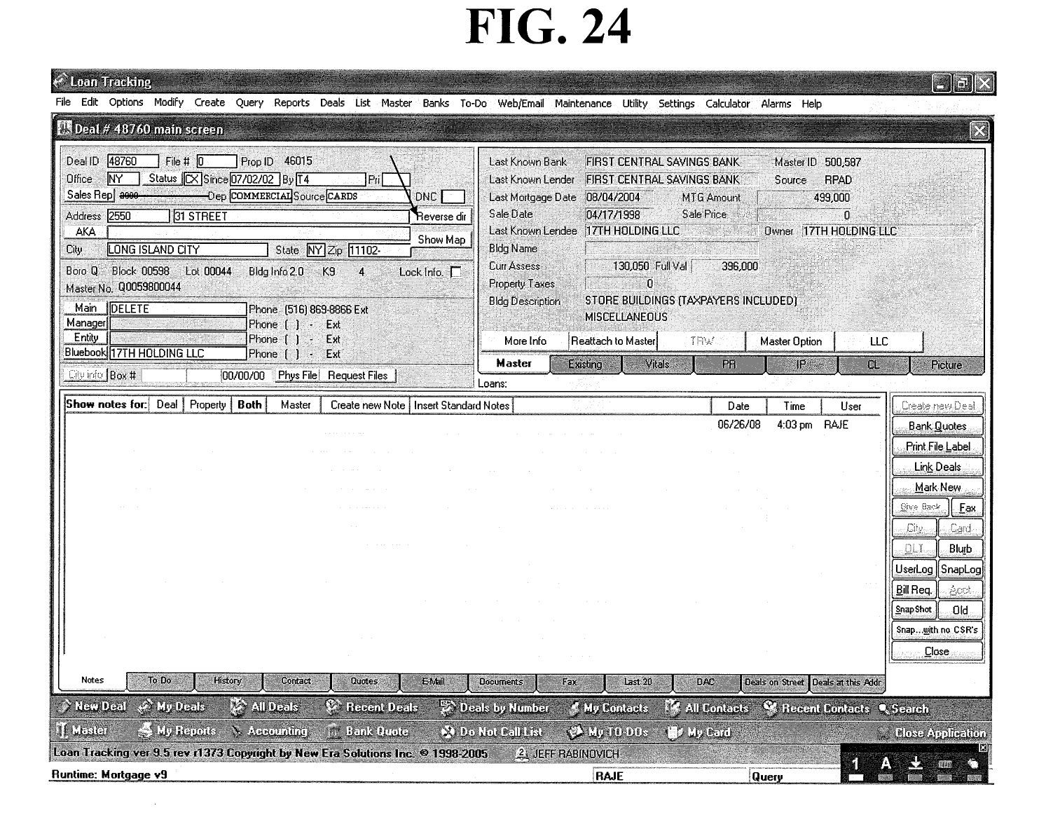

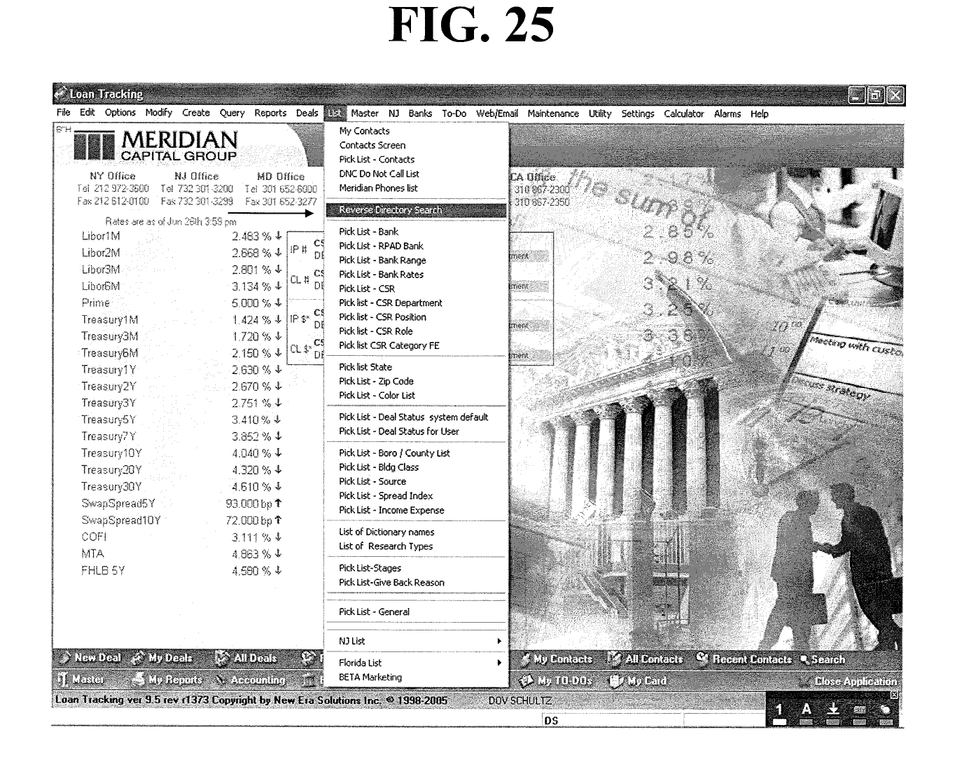

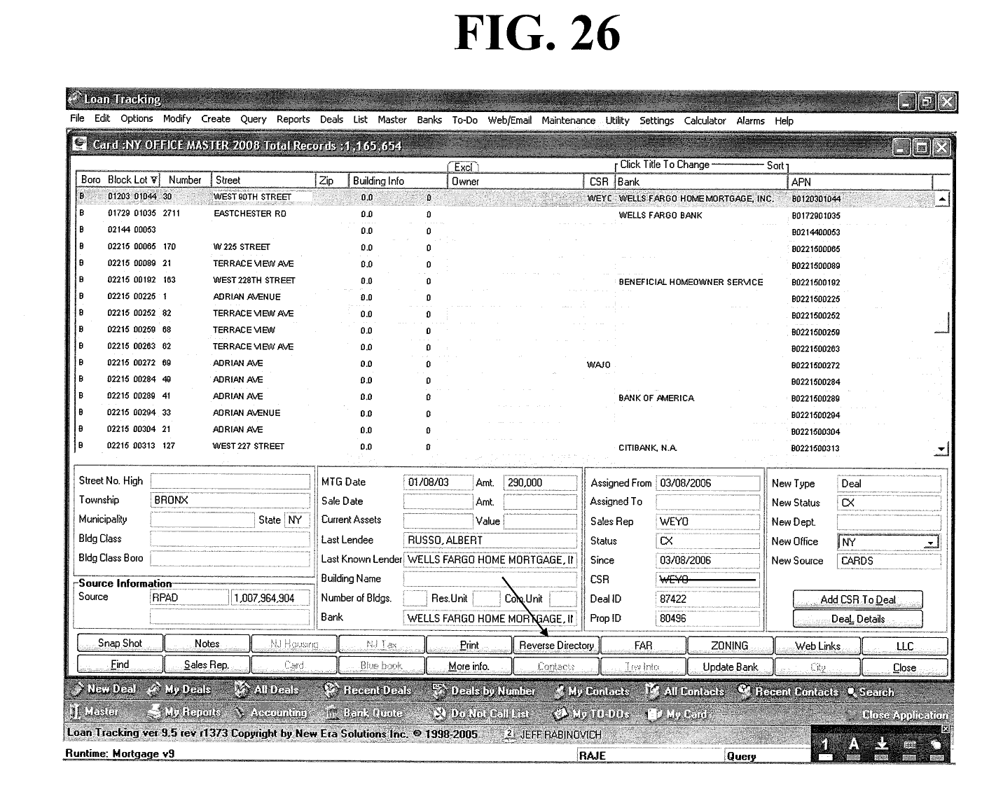

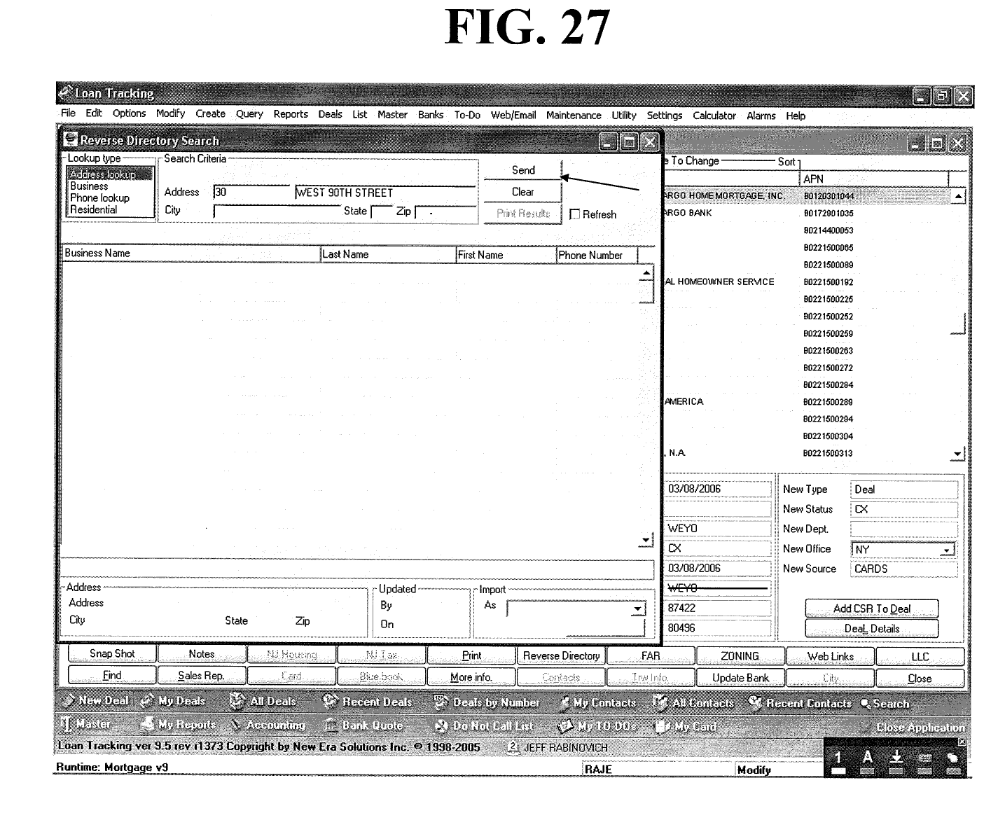

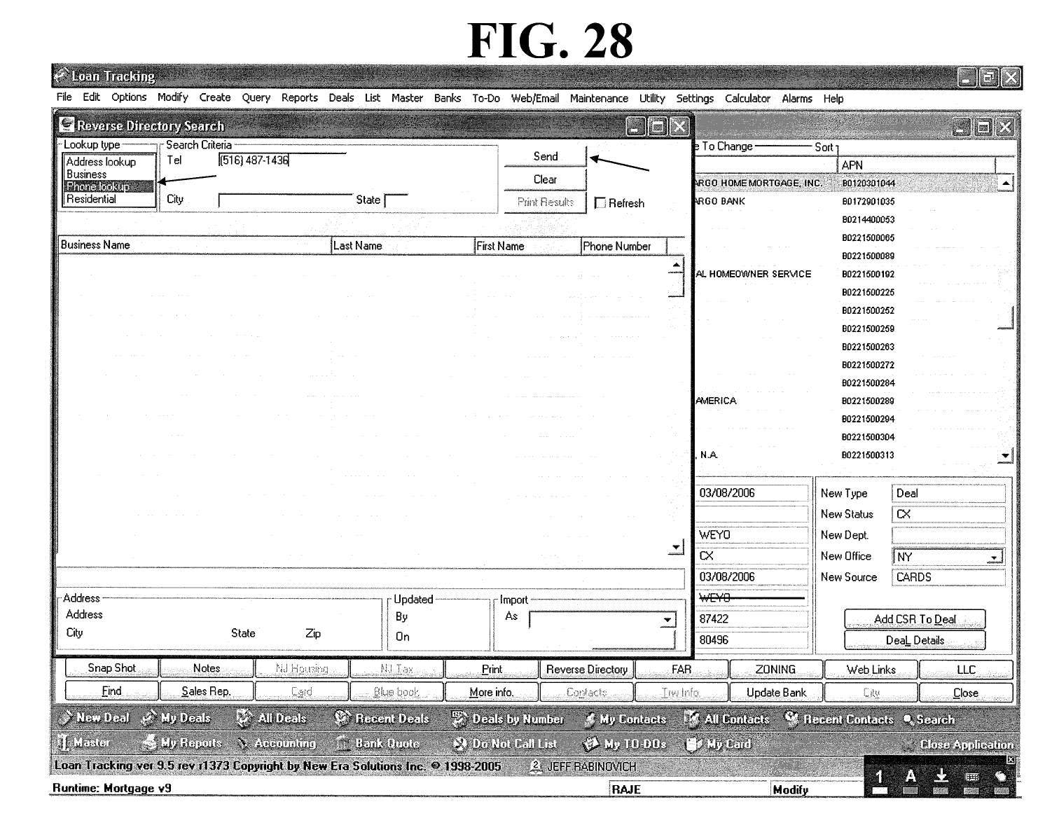

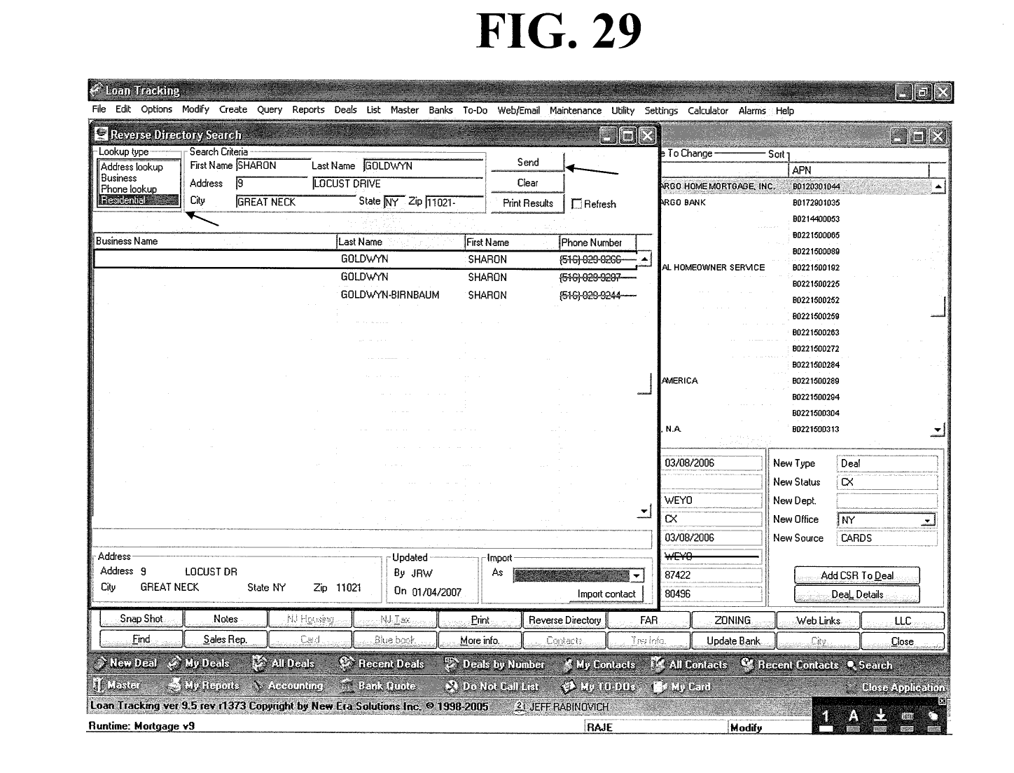

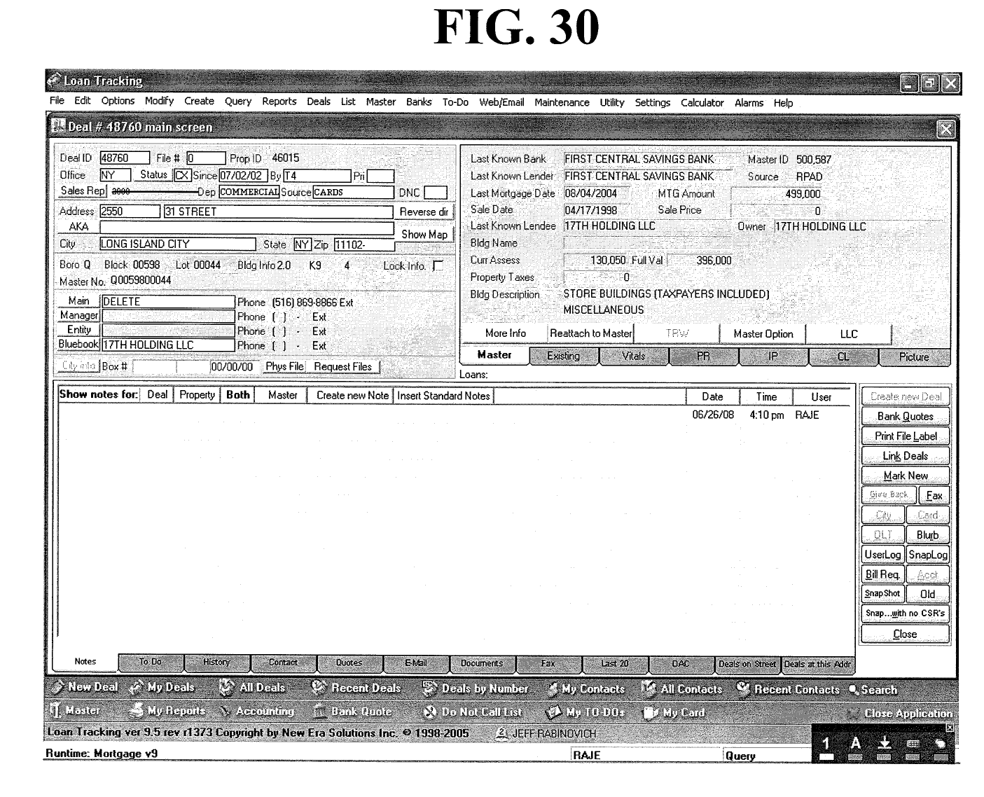

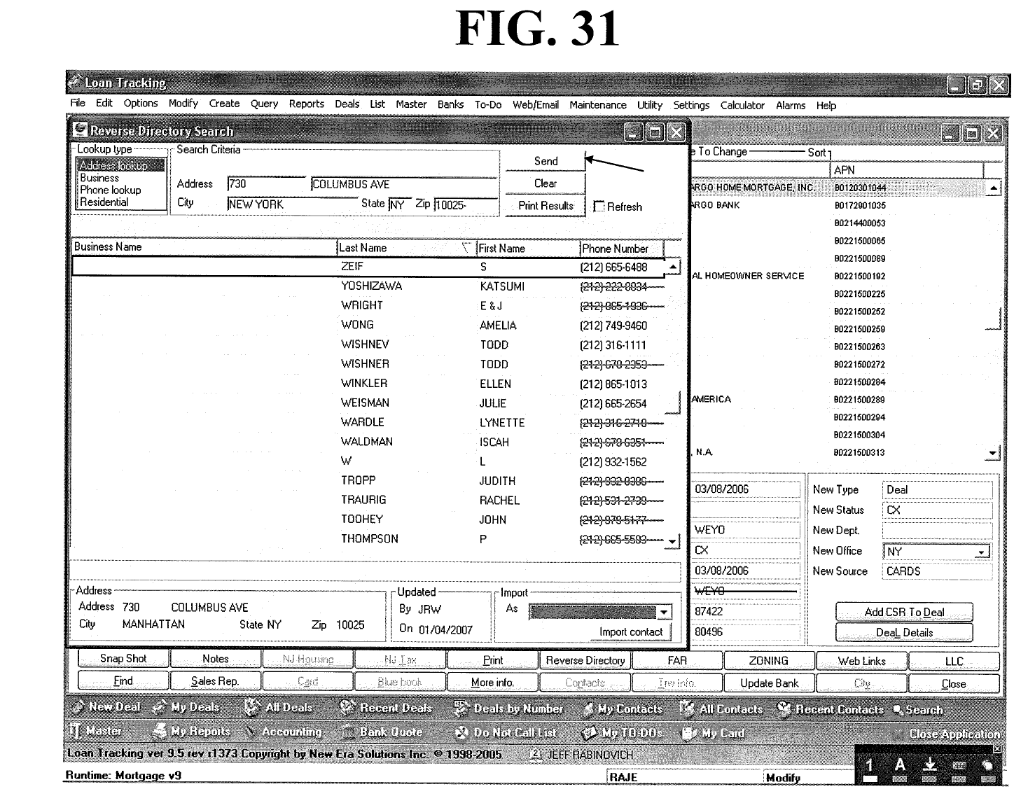

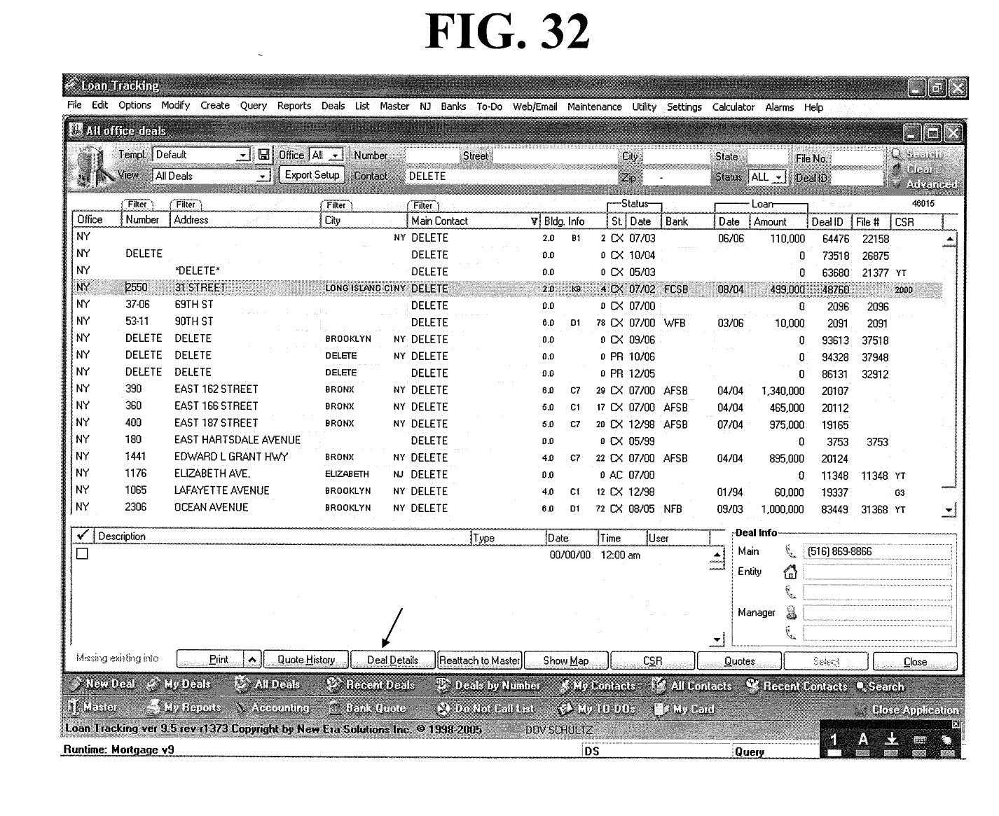

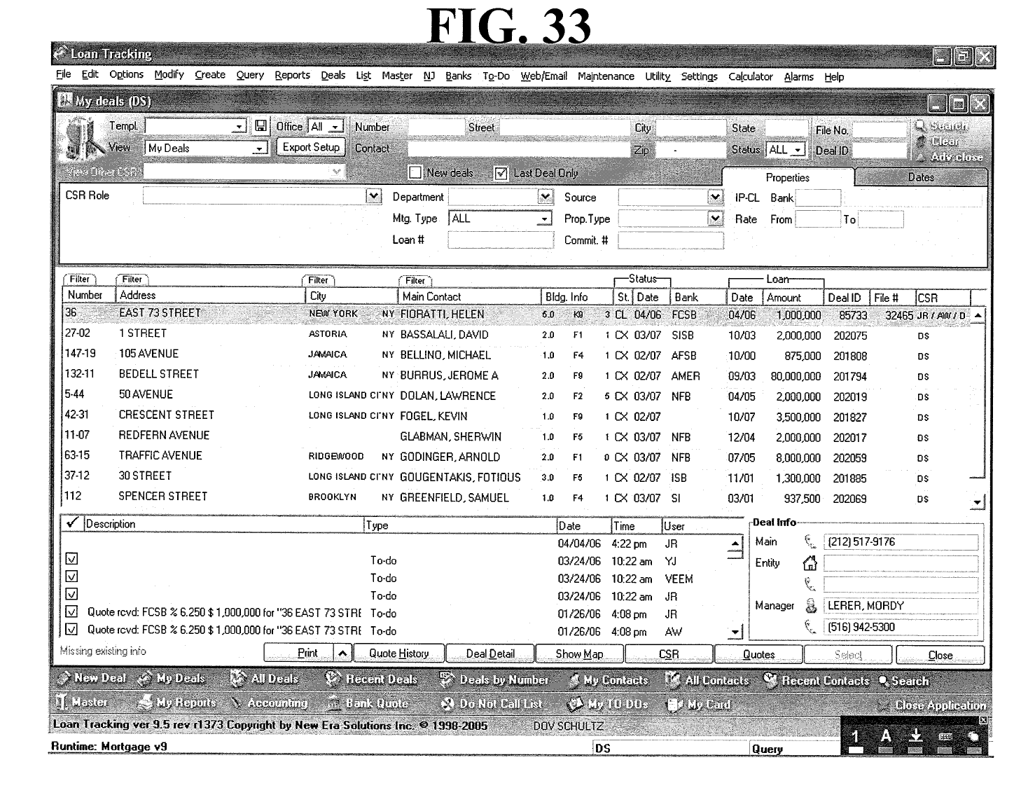

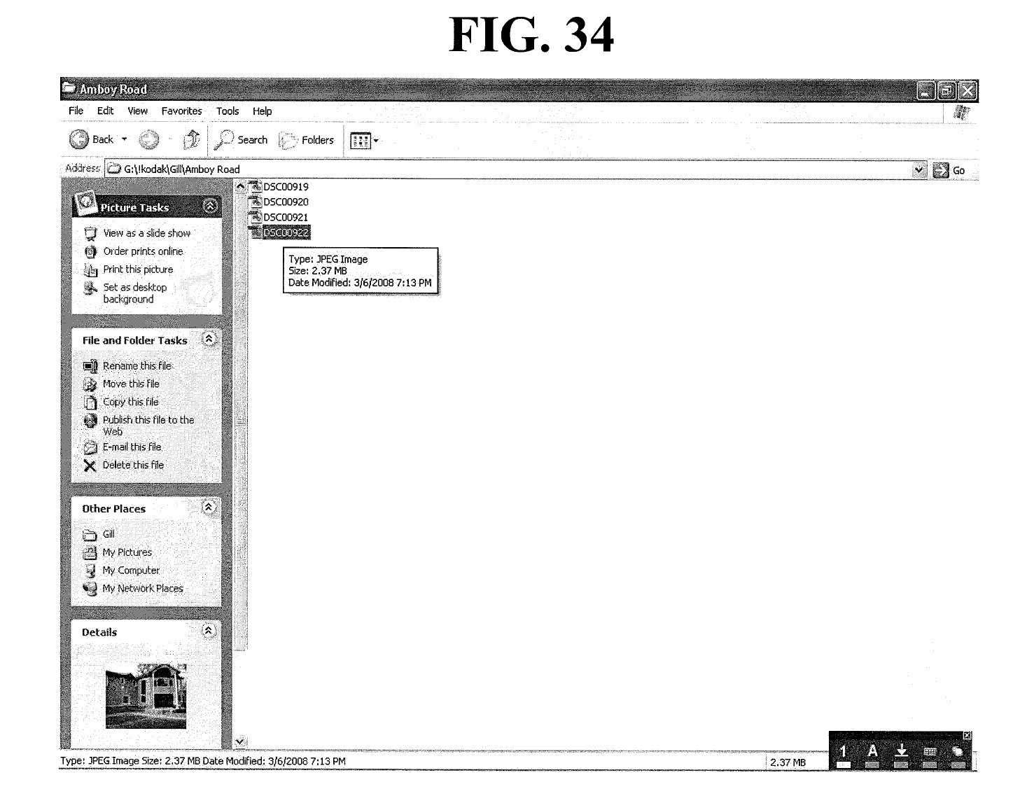

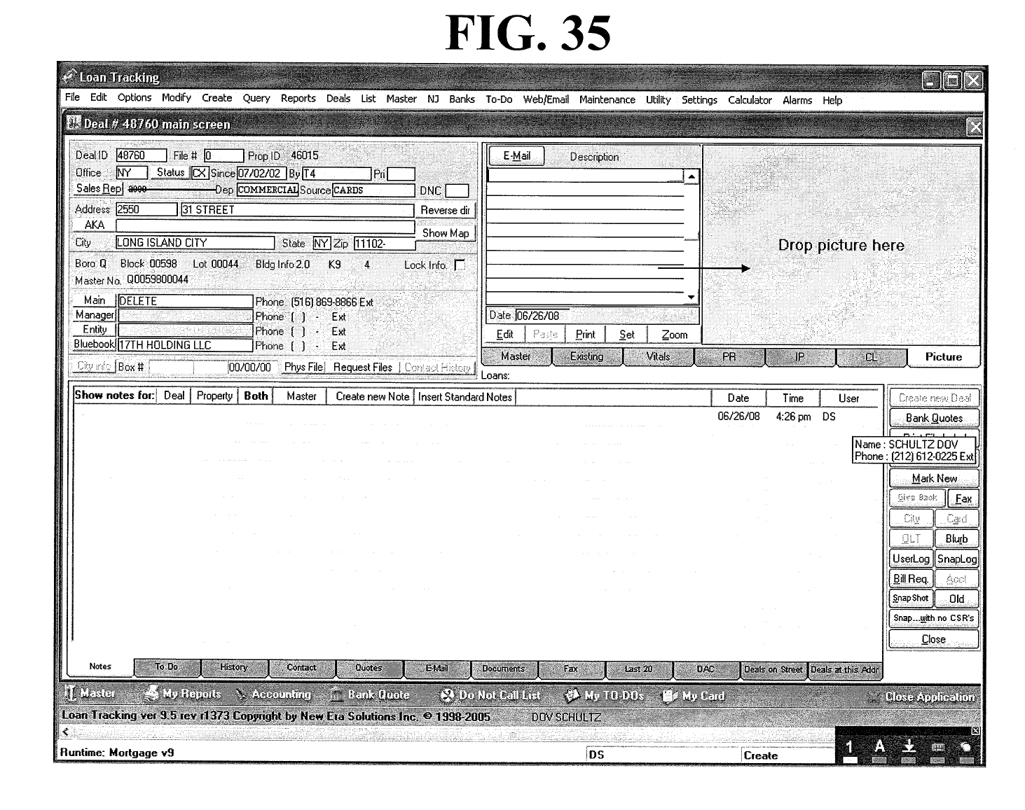

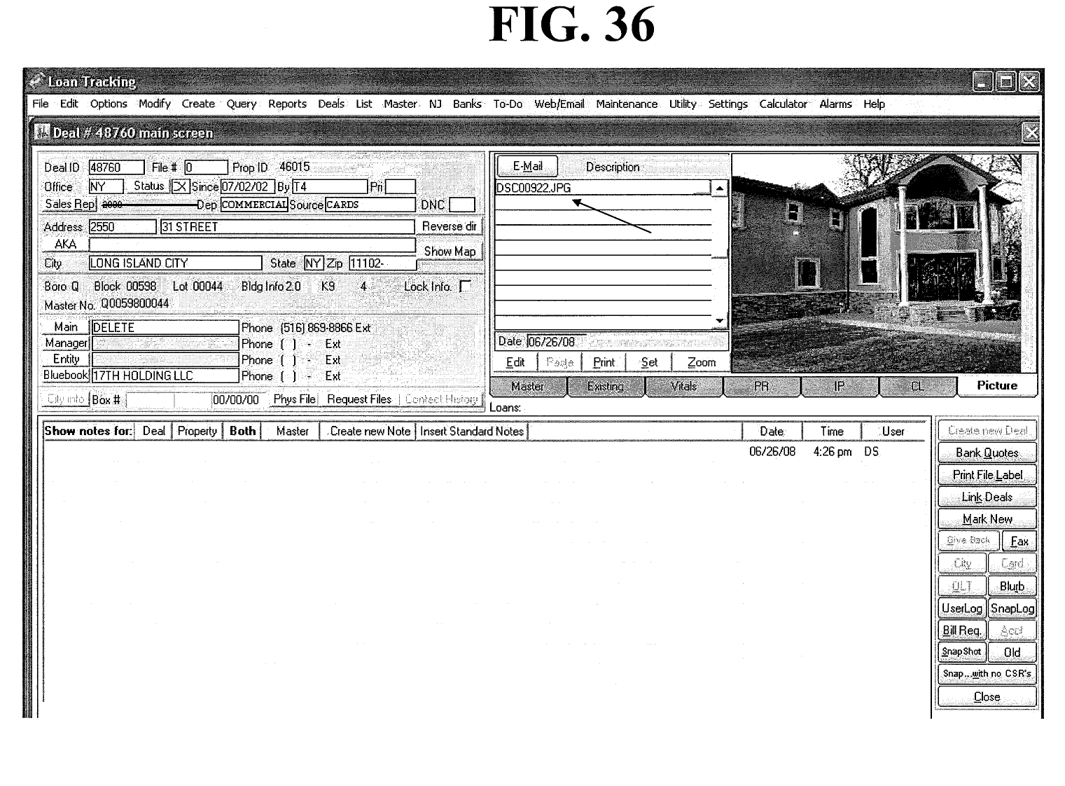

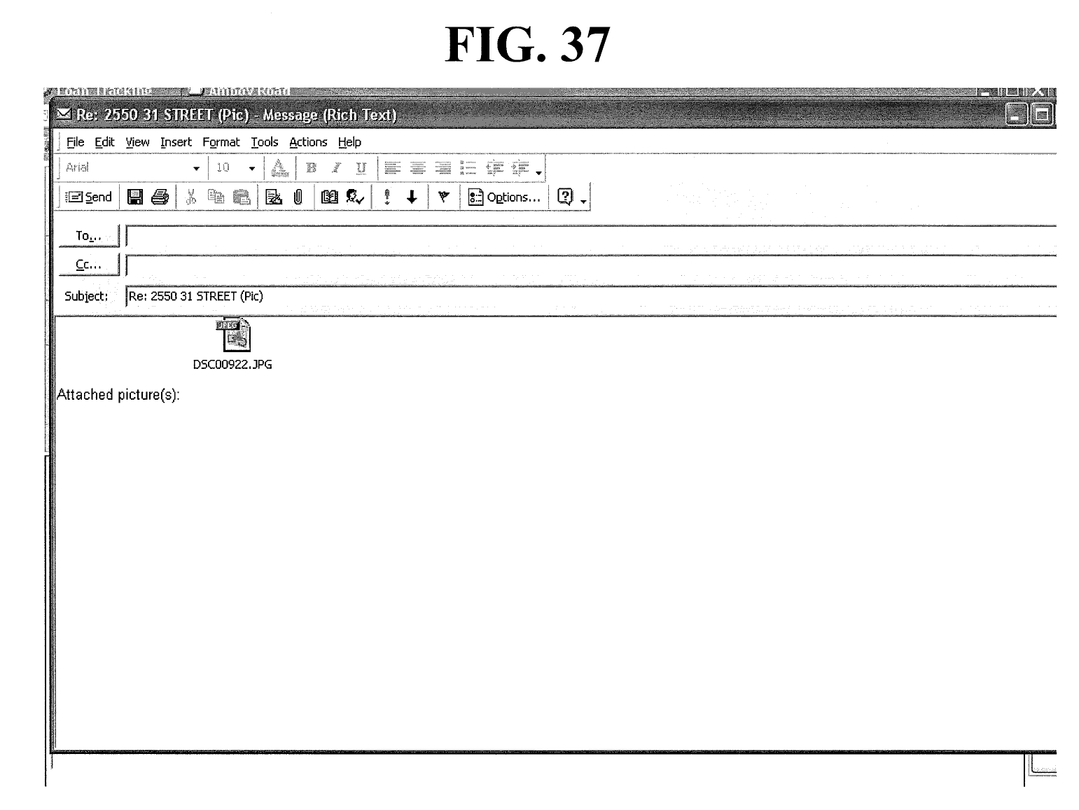

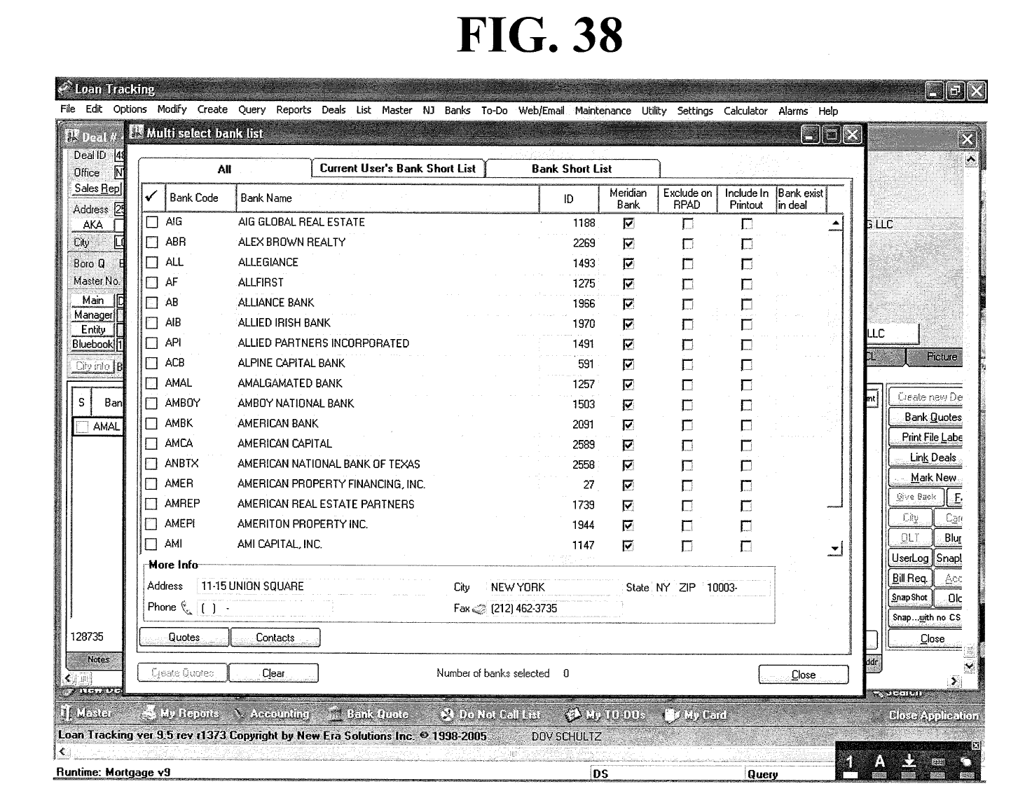

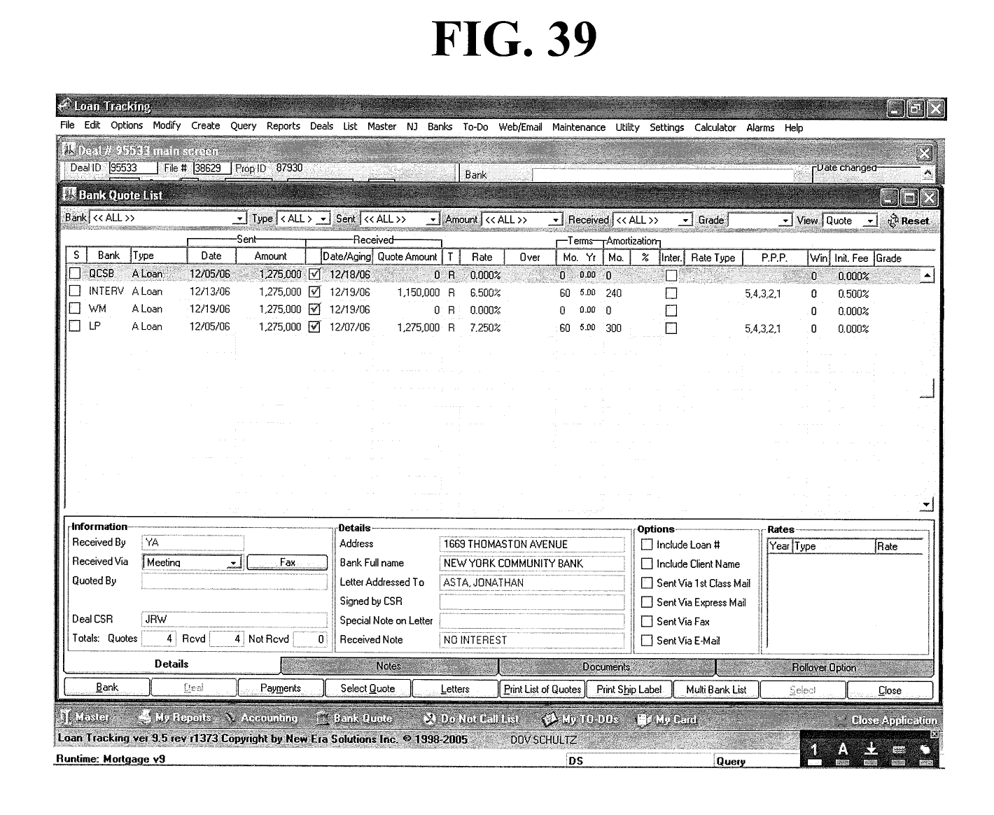

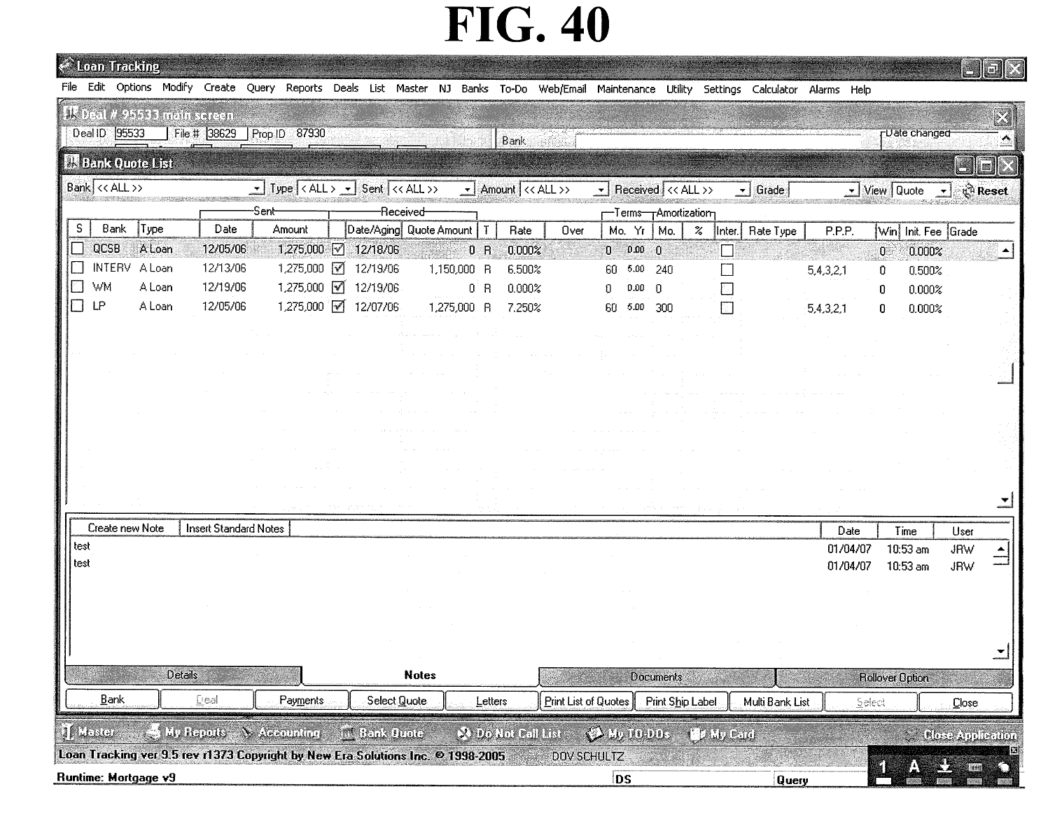

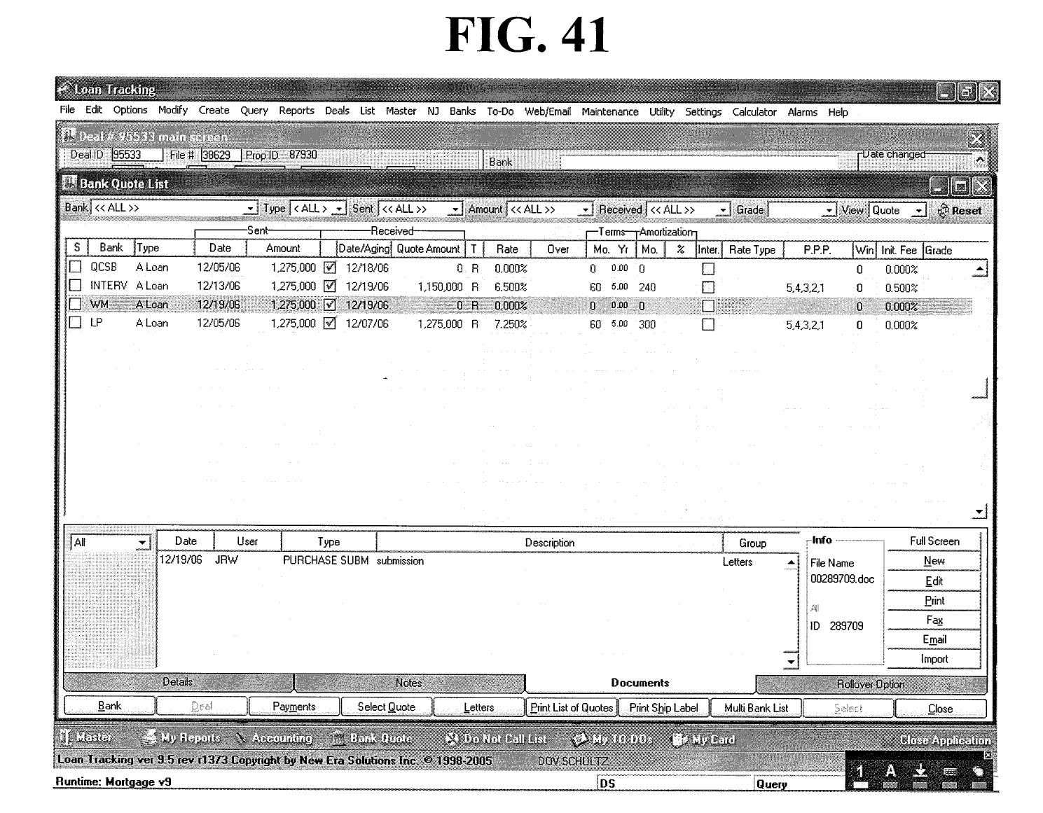

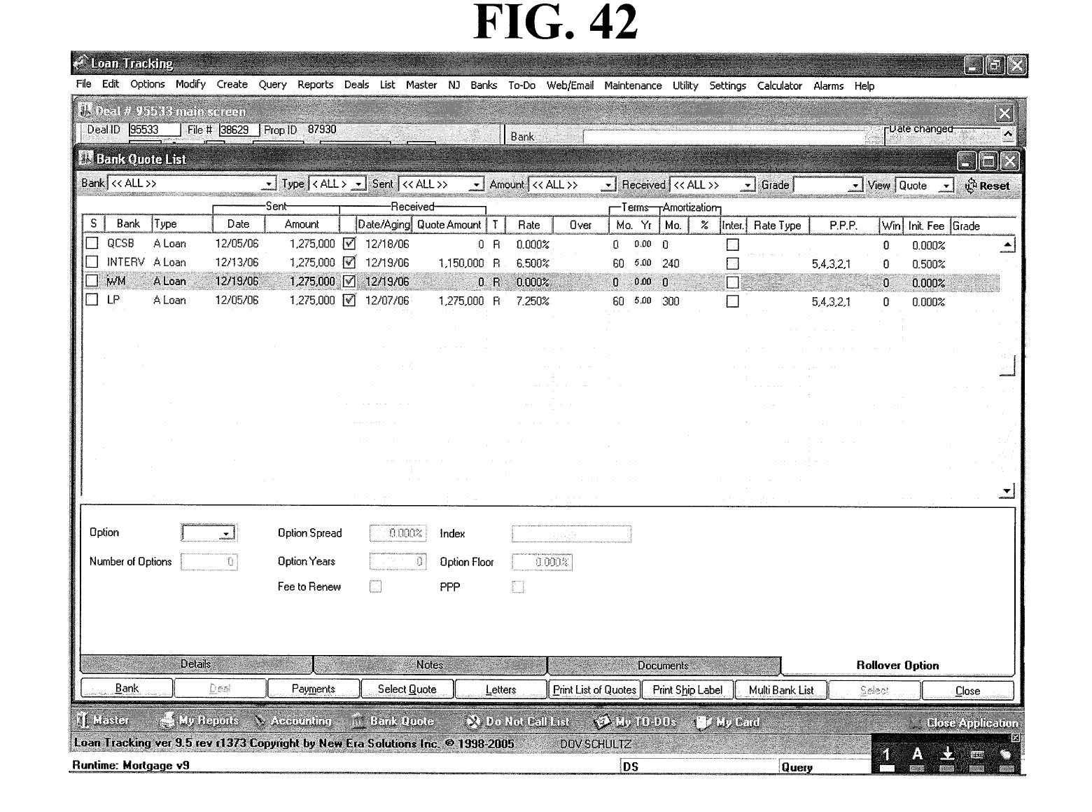

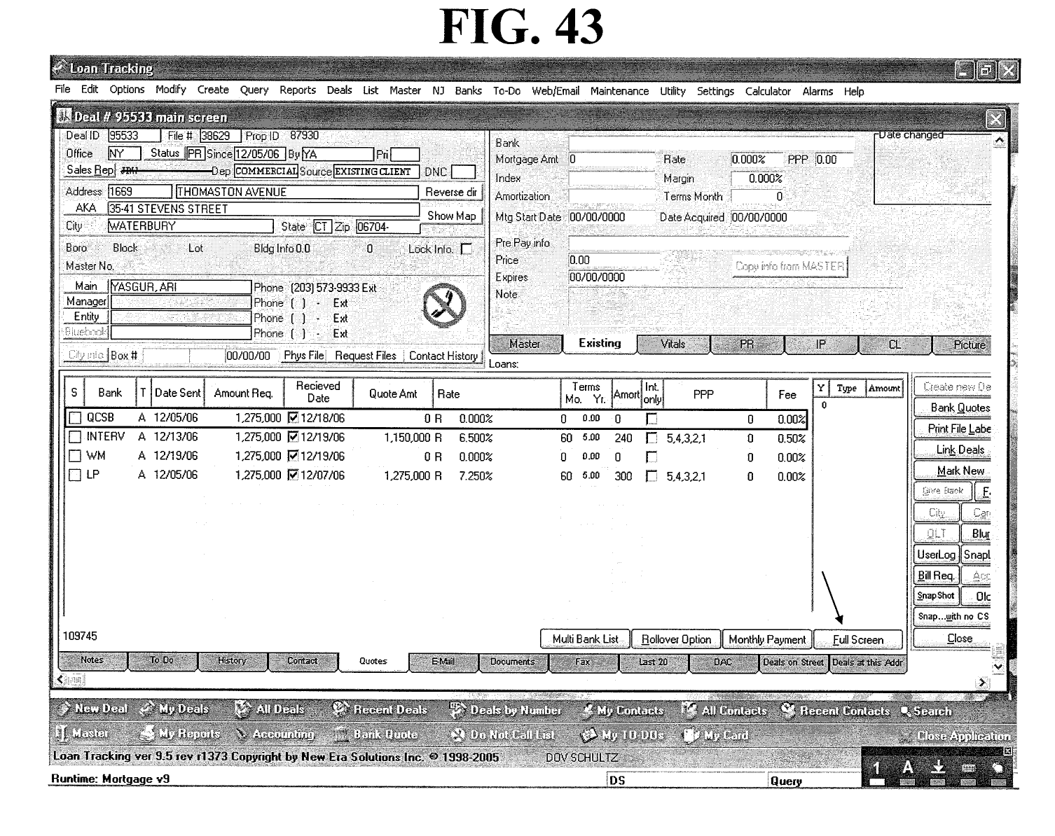

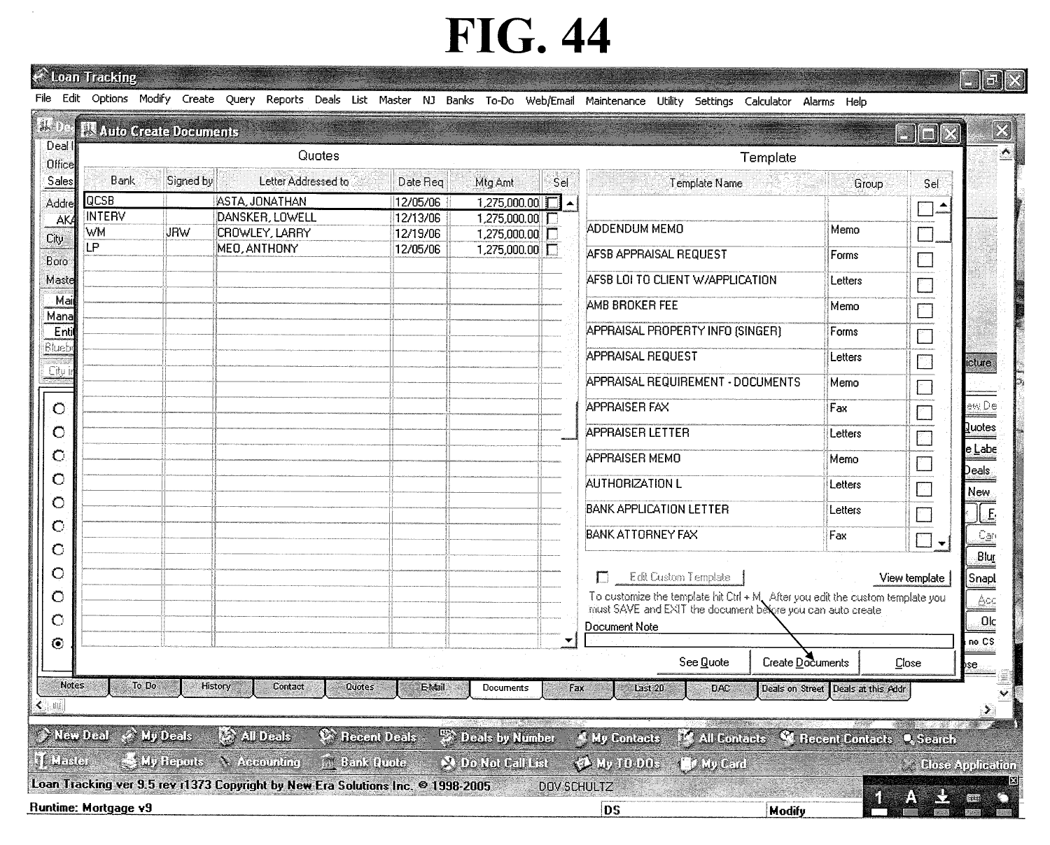

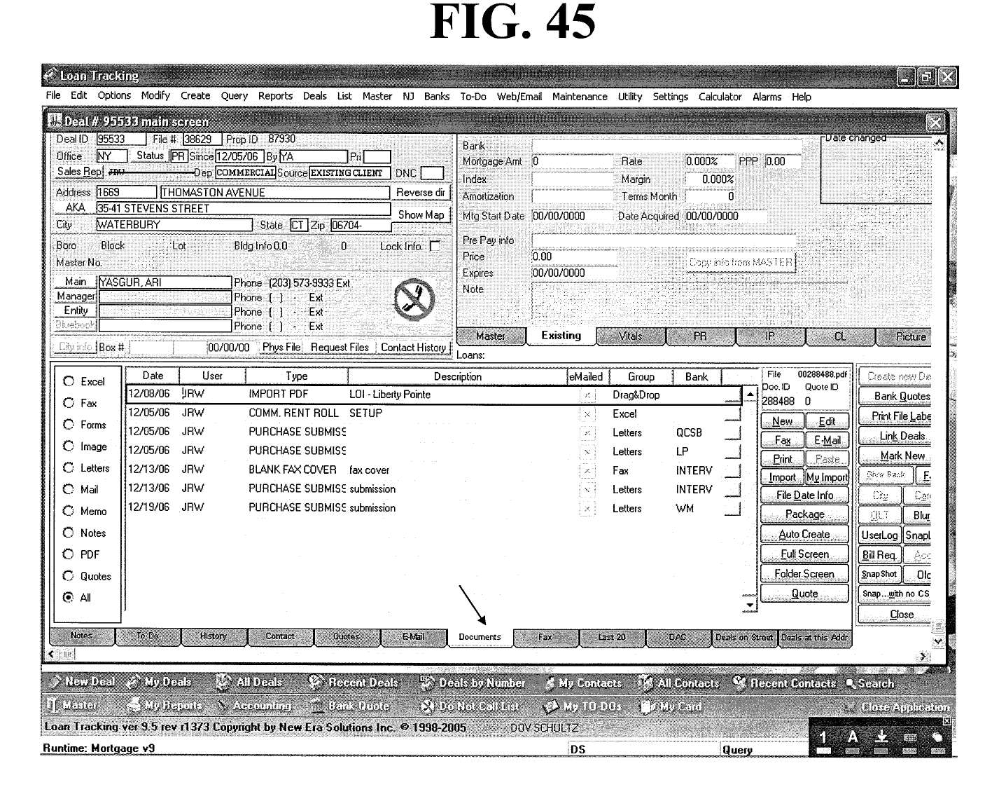

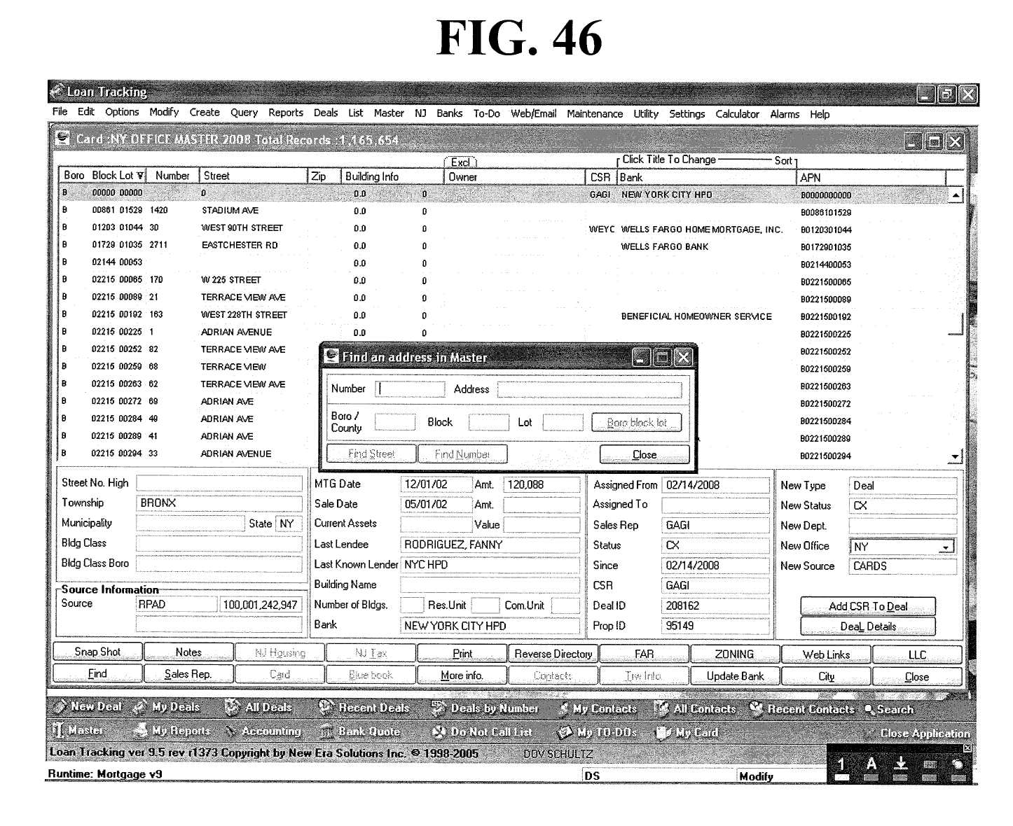

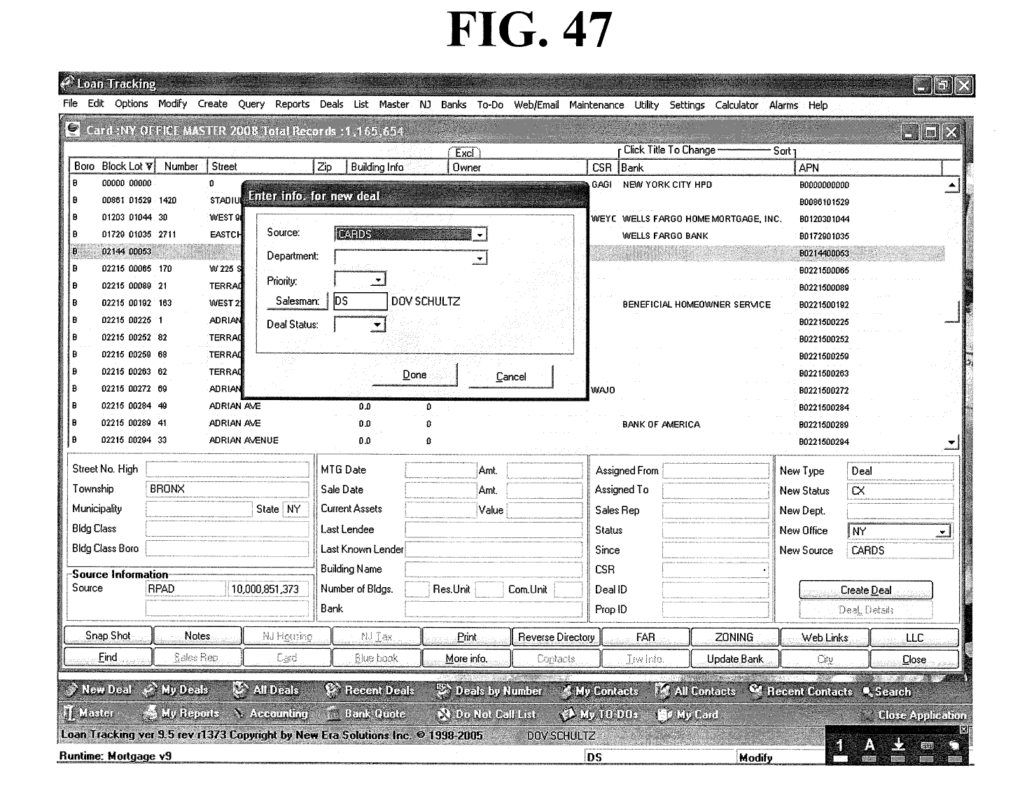

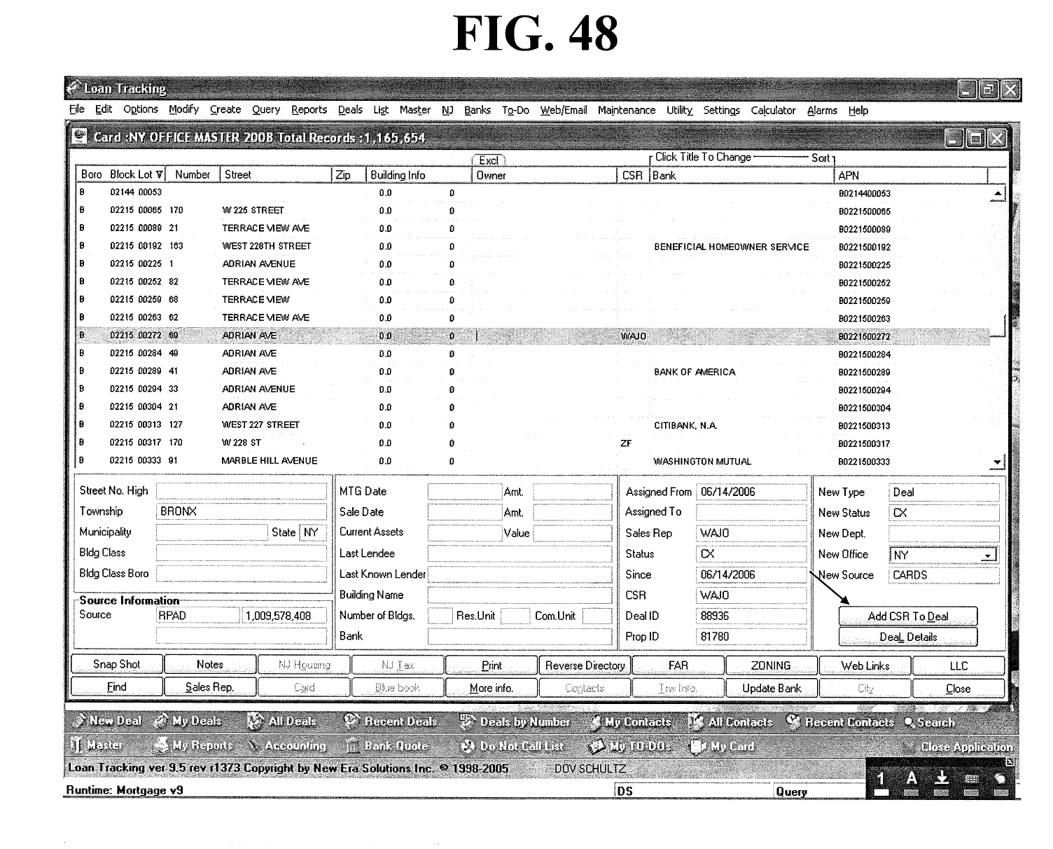

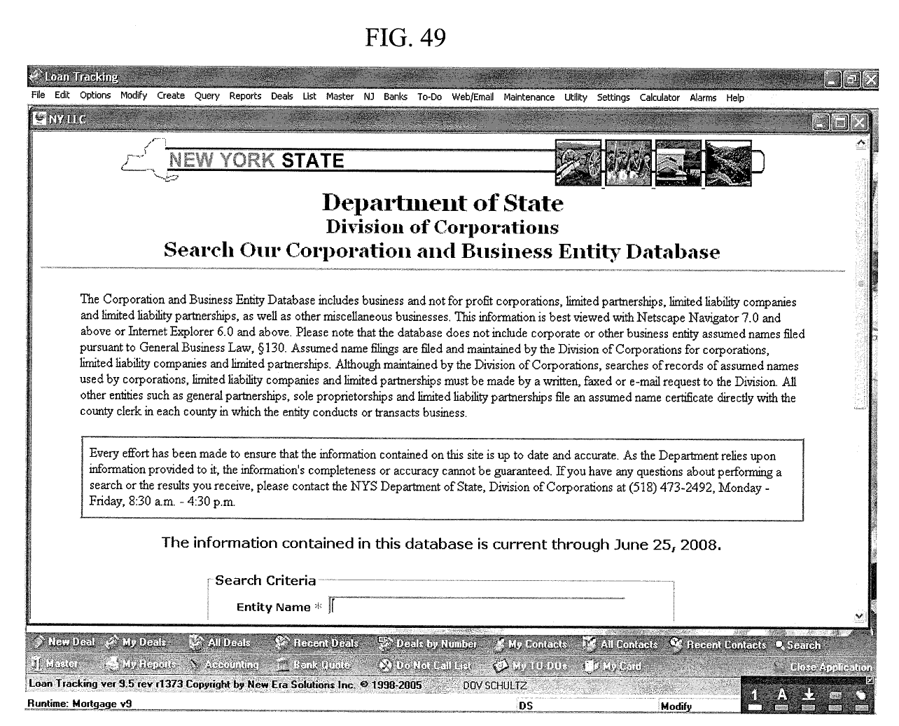

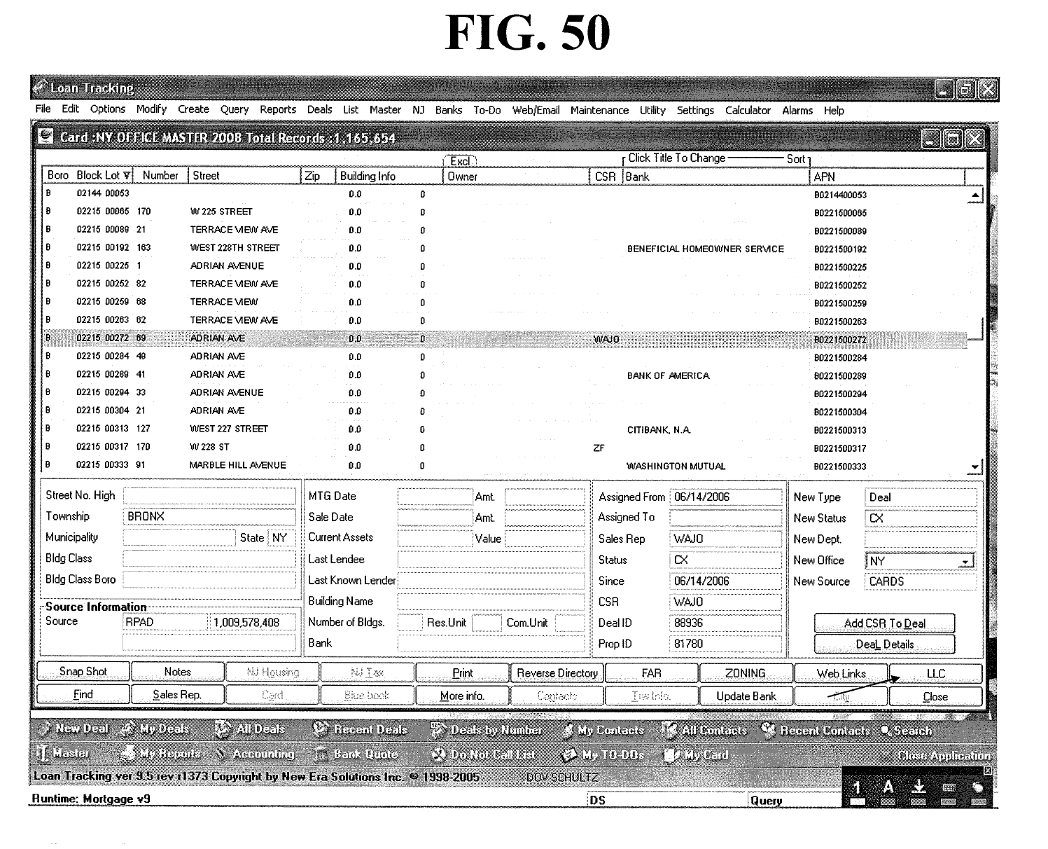

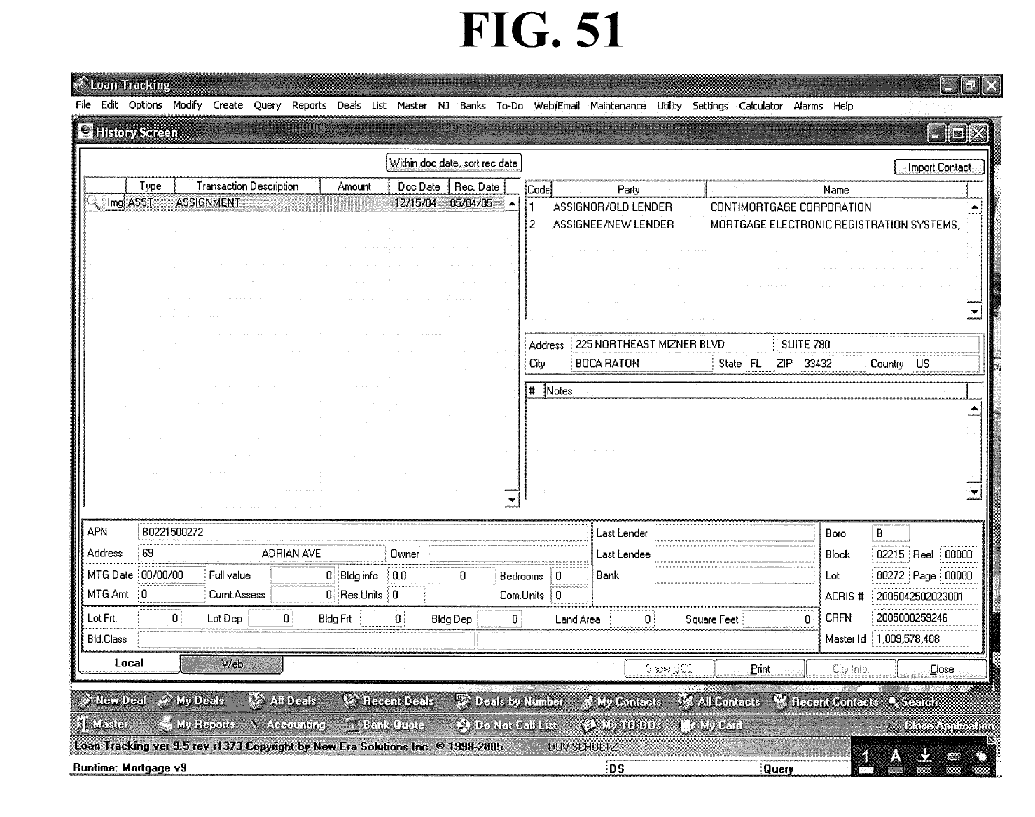

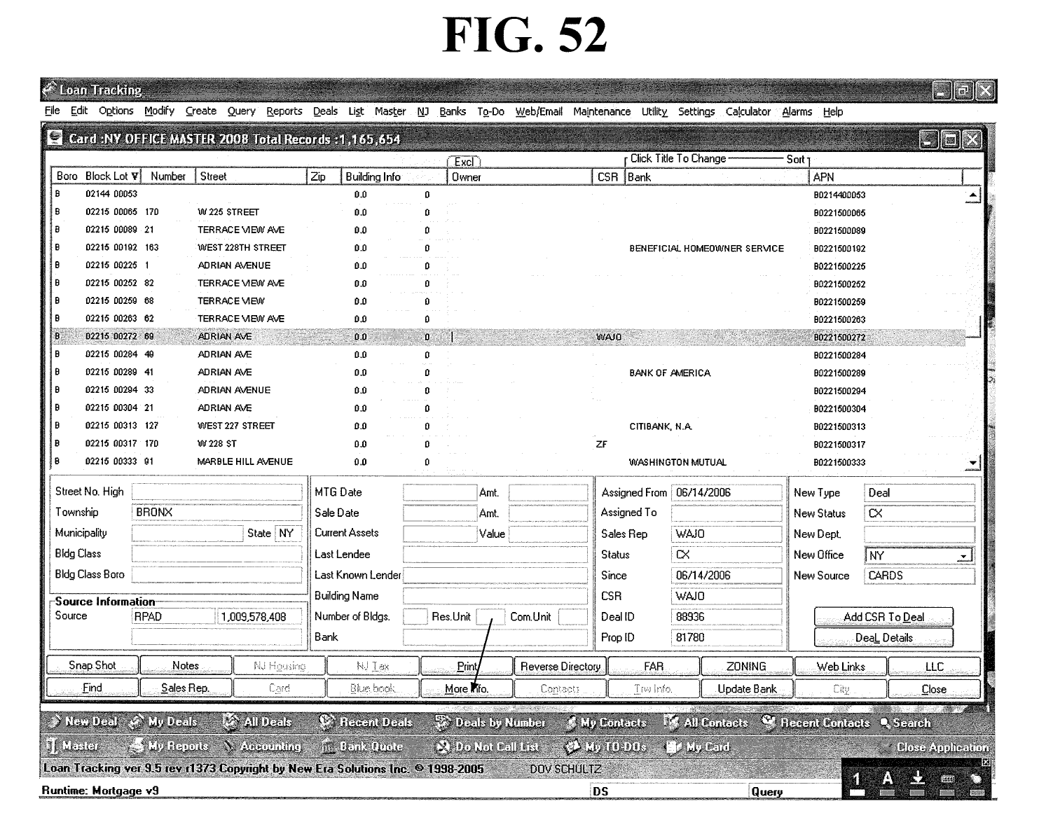

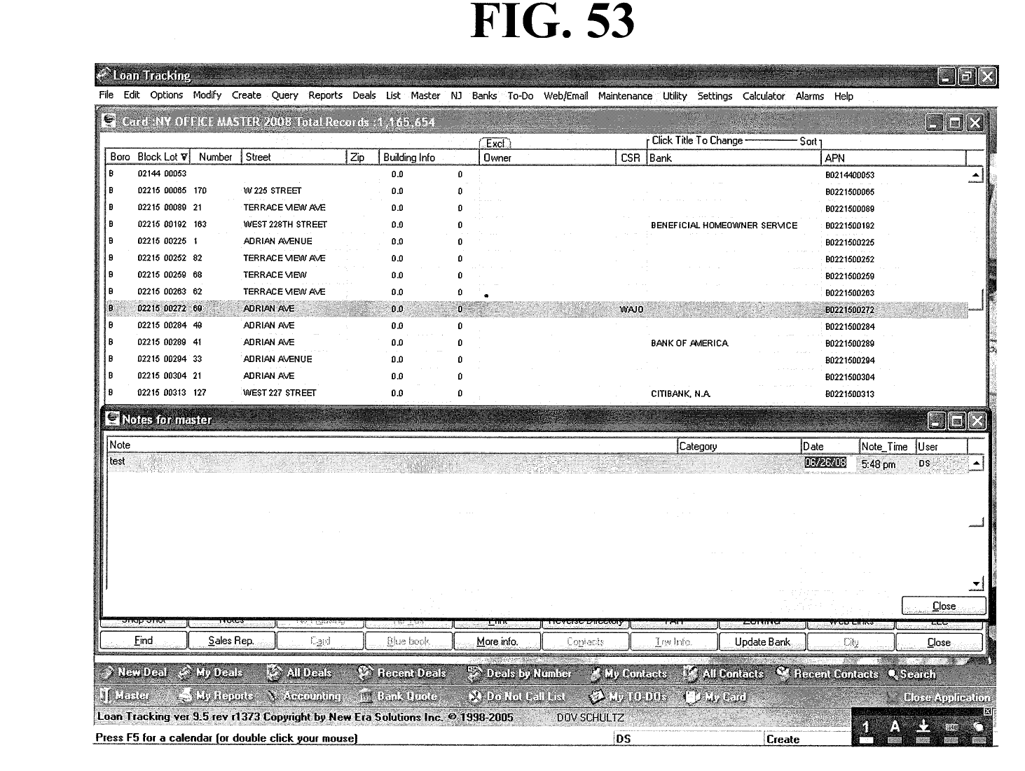

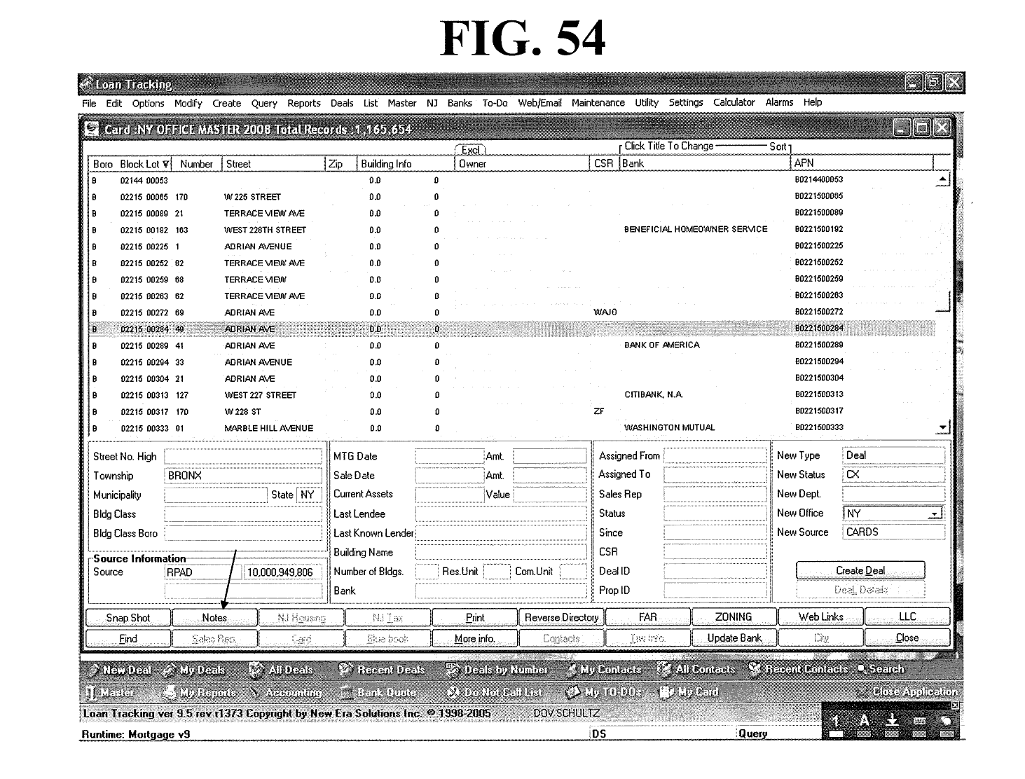

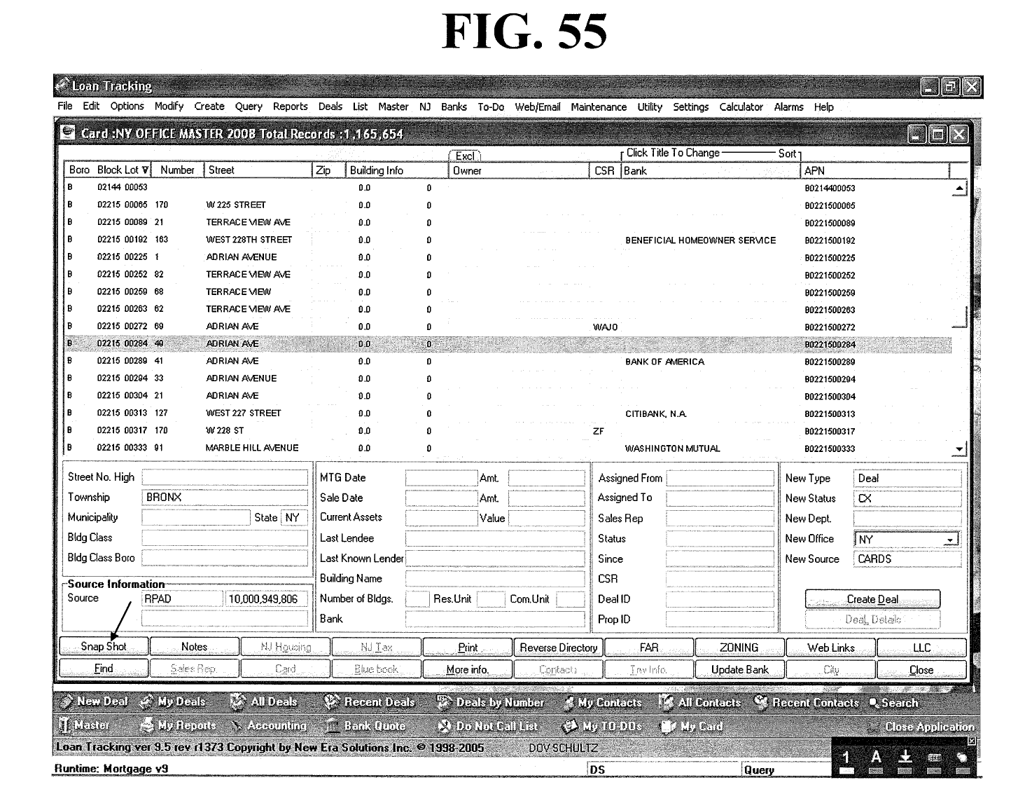

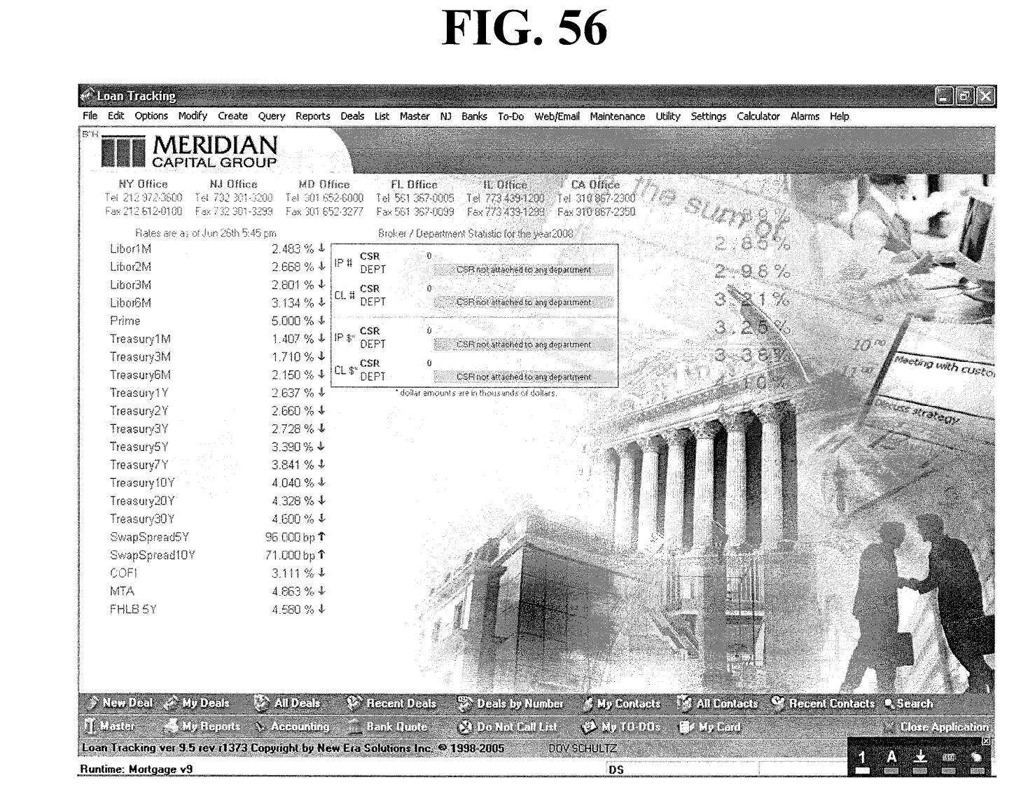

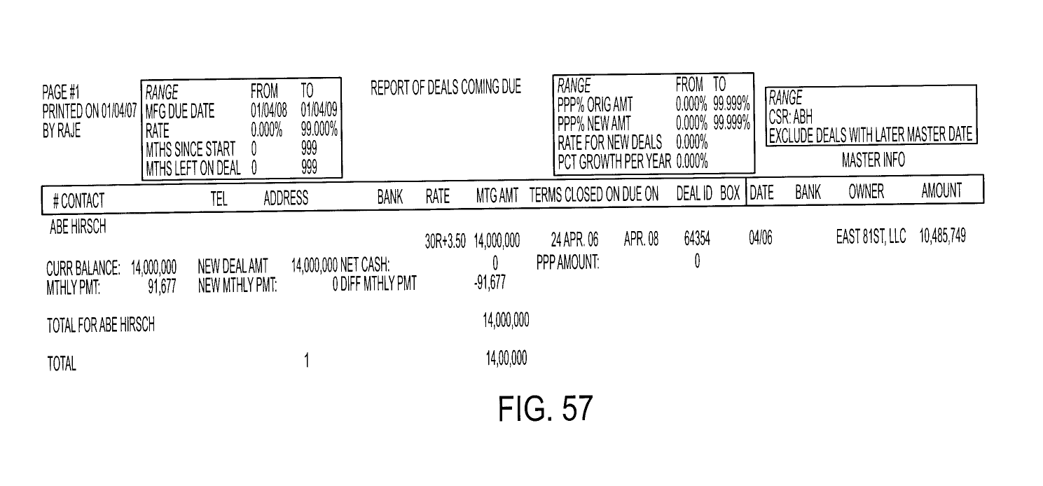

FIGS. 18-57 shows exemplary embodiment of screenshots generated by various modules of the mortgage transaction application according to the present invention.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A method for map-based mortgage information determination, the method comprising:
displaying a geographic location on a map display;
populating the map display with visual property indicators, where each of the property indicators indicate a property having property information associated therewith;
receiving an input selection command including at least one property;
accessing a mortgage data database based on the at least one property;
retrieving mortgage data for the least one property; and
displaying the property information and mortgage data for the at least one property.

2. The method of claim 1 further comprising:
accessing a transaction data database based on the at least one property;
retrieving transaction data for the at least one property; and
displaying the transaction data with the property information and mortgage data for the at least one property.

3. The method of claim 1, wherein the mortgage data database includes data from a plurality of mortgage related documents.

4. The method of claim 1, wherein the mortgage data database includes data from at least one jurisdiction document system.

5. The method of claim 1, wherein the input selection includes an address.

6. The method of claim 1, wherein the input selection includes a geographic region.

7. The method of claim 1, wherein the input selection is received from a mortgage lead generation module.

8. The method of claim 1 further comprising:
receiving a bank list input command; and
launching a bank list module to display a bank list screen interface to identify banks utilized in mortgage transactions.

9. The method of claim 8 further comprising:
receiving bank list display modification input commands; and
updating the bank list display based on these input commands, wherein the bank list input commands include at least one of: displaying a short bank list, displaying all-banks list, displaying banks used for greater then X number of transaction.

10. The method of claim 1 further comprising:
receiving a mortgage document creation input command;
launching a mortgage document creation module; and
creating mortgage documents based on the property information for the at least one property.

11. The method of claim 1 further comprising:
receiving a deal timeline generation input command;
launching a deal timeline module in response to the input command; and
displaying an event timeline for transactions and events relating to a property transaction associated with at least one property.

12. The method of claim 1 further comprising:
receiving a deal summary module input command;
launching a deal summary module; and
displaying a deal summary output display, wherein the deal summary may include the identification of a user and transaction data from a transaction database corresponding to transactions completed and pending involving the user.

13. A system for map-based mortgage information determination, the method comprising:
a memory device having executable instructions stored therein; and
a processing device, in response to the executable instructions, operative to:
display a geographic location on a map display;
populate the map display with visual property indicators, where each of the property indicators indicate a property having property information associated therewith;
receive an input selection command including at least one property;
access a mortgage data database based on the at least one property;
retrieve mortgage data for the least one property; and
display the property information and mortgage data for the at least one property.

14. The system of claim 13, the processing device further operative to:
access a transaction data database based on the at least one property;
retrieve transaction data for the at least one property; and
display the transaction data with the property information and mortgage data for the at least one property.

15. The system of claim 13, wherein the mortgage data database includes data from at least one of: a plurality of mortgage related documents and at least one jurisdiction document system.

16. The system of claim 13, the processing device further operative to:
receive a bank list input command; and
launch a bank list module to display a bank list screen interface to identify banks utilized in mortgage transactions.

17. The system of claim 16, the processing device further operative to:
receive bank list display modification input commands; and
update the bank list display based on these input commands, wherein the bank list input commands include at least one of: displaying a short bank list, displaying all-banks list, displaying banks used for greater then X number of transaction.

18. The system of claim 13, the processing device further operative to:
receive a mortgage document creation input command;
launch a mortgage document creation module; and
create mortgage documents based on the property information for the at least one property.

19. The system of claim 13, the processing device further operative to:
receive a deal timeline generation input command;
launch a deal timeline module in response to the input command; and
display an event timeline for transactions and events relating to a property transaction associated with at least one property.

20. The system of claim 13, the processing device further operative to:
receive a deal summary module input command;
launch a deal summary module; and
display a deal summary output display, wherein the deal summary may include the identification of a user and transaction data from a transaction database corresponding to transactions completed and pending involving the user.
